(19) United States
(12) Patent Application Publication
(10) Pub. No.: US 2013/0339956 A1
(43) Pub. Date: Dec. 19, 2013

(54) COMPUTER SYSTEM AND OPTIMAL ARRANGEMENT METHOD OF VIRTUAL MACHINE IN COMPUTER SYSTEM

(71) Applicants: Kaori Murase, Yokohama (JP); Daisuke Iizuka, Yokohama (JP); Mineyoshi Masuda, Kawasaki (JP)

(72) Inventors: Kaori Murase, Yokohama (JP); Daisuke Iizuka, Yokohama (JP); Mineyoshi Masuda, Kawasaki (JP)

(73) Assignee: HITACHI, LTD., Tokyo (JP)

(21) Appl. No.: 13/991,274

(22) PCT Filed: Mar. 3, 2011
(86) PCT No.: PCT/JP2011/001271

§ 371 Date: Jun. 3, 2013

(51) Int. Cl. G06F 9/455

(52) U.S. Cl. CPC G06F 9/45533
USPC 718/1

(57) ABSTRACT

The present invention obtains an estimated load of a virtual machine which is scheduled to operate from estimated information which operates a virtual machine in a computer system and determines an executing entity of the virtual machine which arranges a computer to be operated before an operation starting time of a virtual machine which is scheduled to operate in the computer system from the estimated load and an actual load of the virtual machine which is being operated.

### TECHNICAL FIELD

The present invention relates to a computer system, and specifically, to a computer system which is suitable for optimal arrangement of a virtual machine in a physical server provided in the computer system. Further, the present invention relates to a method of optimizing an arrangement of a virtual machine in a virtual machine system.

### BACKGROUND

From the viewpoint of effectively utilizing a resource of the computer system, a virtualization technology of a server that allows a computer resource of one physical server to be used in multiple virtual machines (VMs) is known. The virtual machine operates as a virtual server in the physical server so that multiple users effectively use a resource of the physical server (physical machine).

In a computer system in which multiple physical machines and multiple virtual machines are provided, the multiple virtual machines are optimally arranged in the multiple physical machines. It is requested to optimally arrange the virtual machines, for example, the multiple virtual machines are distributed in the multiple physical machines in order to equalize loads between the multiple physical machines in which the multiple virtual machines operates or in contrast, as many virtual machines as possible are concentrated in the same physical machine in order to achieve low power consumption of the computer system.

For the purpose of optimal arrangement of the virtual machines, the virtual machines are rearranged between the multiple physical machines. In the rearrangement of the virtual machines, the virtual machines are migrated between the multiple physical machines. A management server (management computer) of the computer system releases a computer resource of a migration source physical machine from the virtual machine and allocates a computer resource of a migration destination computer to the virtual machine.

For example, Japanese Unexamined Patent Application Publication Nos. 2010-224756 and 2010-211546 disclose a system in which a management computer calculates an appropriate combination of a virtual machine and a physical machine and migrates the virtual machine between multiple physical machines even when the virtual machine is being operated, based on a calculation result, to adjust a balance of loads between the multiple physical machines in which virtual machines are deployed.

### SUMMARY

The system of the related art disclosed in the above-mentioned publications determines an optimal arrangement of the multiple virtual machines in the multiple physical machines in consideration of past load information of the virtual machine and load information of the virtual machine which is expected in the future. However, the system of the related art does not purpose to achieve the optimal arrangement of the virtual machines in consideration of a case where the number of virtual machines is changed.

That is, in the computer system, even though the optimal arrangement of the virtual machines is achieved, an appropriate arrangement state of the virtual machines is adversely affected at a stage where a new virtual machine starts to operate in the physical machine. In order to avoid the adverse effect, at a stage where the new virtual machine operates in the physical machine, the management computer needs to optimally arrange the virtual machines again.

Therefore, the present invention has been made in an effort to provide a computer system in which a load is reduced in a processing of optimally arranging multiple virtual machines in multiple physical machines.

Further, the present invention has been made in an effort to provide a computer system which prevents an appropriate arrangement state of virtual machines which are operating from being damaged even when a new virtual machine starts to operate in the physical machine.

In addition, the present invention has been made in an effort to provide a method of optimizing an arrangement of virtual machines in a computer system.

In order to achieve the above objects, the present invention obtains an estimated load of a virtual machine which is scheduled to be operated from estimated information which operates a virtual machine in a computer system and determines an executing entity of the virtual machine which arranges a computer to be operated before an operation starting time of the virtual machine which is scheduled to be operated in the computer system from the estimated load and an actual load of the virtual machine which is being operated.

As described above, according to the present invention, it is possible to provide a computer system in which a load is reduced in a processing of optimally arranging multiple virtual machines in multiple physical machines. Further, according to the present invention, it is possible to provide a computer system which prevents an appropriate arrangement state of virtual machines which are operating from being damaged even when a new virtual machine starts to operate in the physical machine. In addition, according to the present invention, it is possible to provide a method of optimizing the arrangement of virtual machines in the computer system described above.

### BRIEF DESCRIPTION OF THE DRAWINGS

FIG. 1 is a configuration view of hardware of a computer system according to a first embodiment;

FIG. 2 is an example of a configuration table of a physical machine according to the first embodiment;

FIG. 3 is an example of an information table of a virtual machine according to the first embodiment;

FIG. 4 is an example of a reservation information table according to the first embodiment;

FIG. 5 is a flowchart of an optimal arrangement processing of a virtual machine which is scheduled to be operated according to the first embodiment;

FIG. 6 is an arrangement score table according to the first embodiment;

FIG. 7 is a flowchart of an arrangement determination processing of a virtual machine which is scheduled to be operated according to the first embodiment;

FIGS. 8A, 8B and 8C are a physical machine configuration table, a VM information table, a reservation information table according to a second embodiment;

FIG. 9 is a flowchart of an optimal arrangement processing of a virtual machine according to the second embodiment;

FIG. 10 is a flowchart of an optimal arrangement plan creating processing of a virtual machine which is being operated and a virtual machine which is scheduled to be operated according to the second embodiment;

FIGS. 11A, 11B and 11C are a physical machine configuration table, a VM information table, a reservation information table according to a third embodiment;

FIG. 12 is a flowchart of an optimal arrangement processing of a virtual machine which is scheduled to be operated according to the third embodiment;

FIG. 13A is a physical machine information table as a management table relating to a state in which a resource management program does not need to consider an ending time of the virtual machine which is being operated when determining an arrangement of the virtual machines which are scheduled to be operated;

FIG. 13B is a VM information table as a management table relating to a state in which a resource management program does not need to consider an ending time of the virtual machine which is being operated when determining an arrangement of the virtual machines which are scheduled to be operated;

FIG. 13C is a reservation information table as a management table relating to a state in which a resource management program does not need to consider an ending time of the virtual machine which is being operated when determining an arrangement of the virtual machines which are scheduled to be operated;

FIG. 14 is a graph illustrating a displacement of a load of the virtual machine with respect to a total capacity of a memory of the physical server;

FIG. 15 is a modification of the reservation information table of FIG. 13C;

FIG. 16 is a graph illustrating a displacement of a load of the virtual machine with respect to a total capacity of a memory of the physical server, which corresponds to FIG. 15;

FIG. 17 is a graph illustrating a status where a load of the multiple virtual machines is accumulated;

FIG. 18 is a reservation information table according to a modification of FIG. 15;

FIG. 19 is a graph of a modification of FIG. 16;

FIG. 20 is a graph of a modification of FIG. 17;

FIG. 21 is an example of a reservation information input screen of the virtual machine which is displayed on a display by a resource management program through an output I/F;

FIG. 22 is an example of an input screen to request to output an optimal arrangement plan of the virtual machines; and

FIGS. 23A, 23B and 23C are management tables corresponding to an arrangement form of multiple virtual machines obtained by the optimal arrangement processing of the virtual machine.

### DETAILED DESCRIPTION

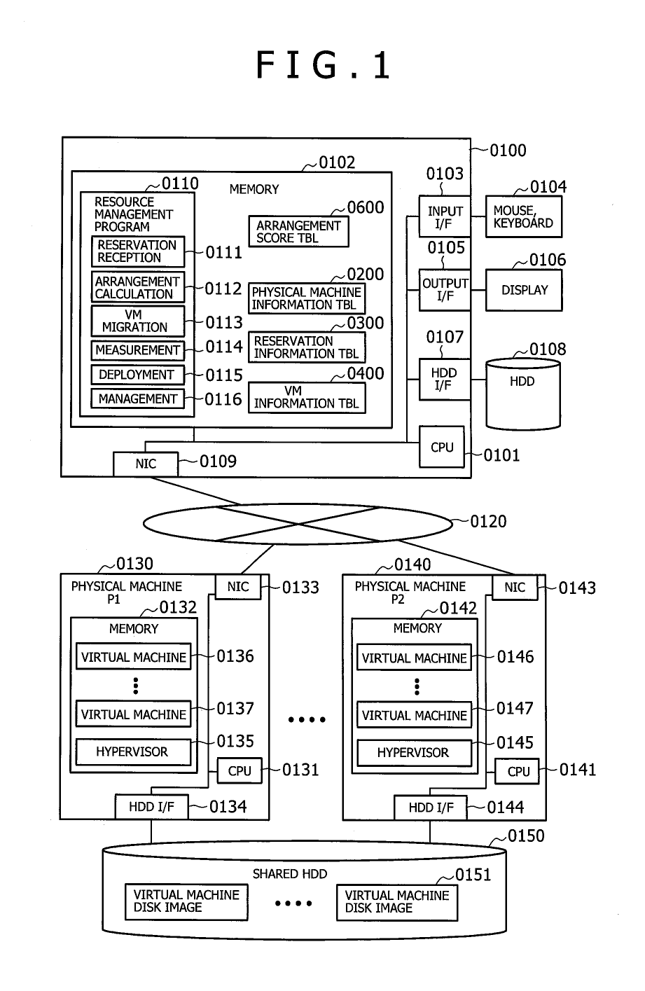

Next, an embodiment of a computer system according to the present invention will be described. FIG. 1 illustrates a hardware block of the computer system. The computer system includes multiple physical machines 0130, 0140, . . . , a resource management server 0100 which manages the arrangement of virtual machines between the physical machines, and a network 0120 which connects the multiple physical machines and the management server.

The resource management server 0100 includes a CPU 0101, a memory 0102, a network interface card (illustrated as NIC) 0109, an input I/F 0103, an output I/F 0105, and an HDD I/F 0107.

The input I/F 0103 of the resource management server 0100 is connected with an input device such as a mouse or a keyboard 0104 to receive manipulation from a user of the resource management server 0100. The output I/F 0105 is connected to an output device such as a display 0106 to output a screen to the user. If a printer is an output device, the output I/F 0105 is also connected with the print (not illustrated).

The HDD I/F 0107 is connected with an HDD 0108 which is an external storage to store various programs or various data and tables which are processed in the CPU 0101. The NIC 0109 is connected to the network 0120 to be connected with other physical machines 0130, 0140.

In the memory 0102, a resource management program 0110 is mounted. The resource management program 0110 may be stored in the HDD 0108 to be loaded in the memory 0102 in response to a request from the CPU 0101. The resource management program 0110 executes a reservation accept processing 0111, an arrangement calculation processing 0112 of a virtual machine, a migration processing 0113 of the virtual machine, a measurement processing 0114 which calculates a load of a virtual machine which is being operated, a deployment processing 0115 which allows a user of the virtual machine to use a virtual machine which is scheduled to be operated at an appointed time, and a management processing 0116 which collects and manages load information and configuration information of a virtual machine which operates in the physical machines 0130 and 0140 or a hypervisor from the physical machines 0130 and 0140 or the hypervisors 0135 and 0145. Each of the processings is achieved by one of flowcharts which will be described below or a combination thereof or one or plural steps of these flowcharts.

In the memory 0102, a physical machine information table TBL 0200 which stores information regarding a total resource amount which is allocated to the virtual machines 0136 and 0146 from the physical machines by the hypervisors 0135 and 0145 is stored. The total resource amount is collected from each of the physical machines 0130 and 0140 by the resource management program 0110.

The memory 0102 further includes a management table such as a reservation information table 0300 in which information regarding a schedule to operate the virtual machine created based on an input from a user of the virtual machine is stored, a VM information table 0400 in which load information of the virtual machine which is being operated or information of a physical machine in which the virtual machine operates is stored, and an arrangement score table 0600 in which priority information when determining a physical machine in which a virtual machine is arranged is stored.

The resource management program 0110 performs a read processing or a write processing on the management table in the process of a resource management processing. Further, the management table may be stored in the HDD 0108. The CPU 0101 reads out the management table from the HDD 0108 to be loaded in the memory 0102 and stores the management table in the HDD 0108.

The physical machines 0130 and 0140 include a hardware configuration same as the resource management server 0100 and include CPUs 0131, 0141, memories 0132, 0142, NICs 0133, 0143 for network connection with the resource management server 0100, and HDD I/Fs 0134 and 0144 for connection with a shared storage (shared HDD) 0150, respectively. Similarly to the resource management server 0100, the physical machines may include an input I/F 0103 and an output I/F 0105. Further, in order to distinguish the physical machines, an identifier of the physical machine 0130 is denoted by P1, an identifier of the physical machine 0140 is denoted by P2, and identifiers of third or subsequent physical machines are denoted by P3, P4, . . .

The hypervisors 0135 and 0145 are loaded in the memories 0132 and 0142 of the physical machines to perform various management processings for the virtual machine such as generation of one or plural virtual machines 0136 . . . 0137, 0146 . . . 0147, a change of a specification of the virtual machines, deletion, and migration of the virtual machines, and allocation of a computer resource of the physical machine to the virtual machine.

The computer resource is, for example, one or plural of the CPU, the memory, a hard disk drive, a network bandwidth of the NIC, and a disk I/O which are provided in the computer. The computer resource includes a logical resource such as a volume, a host group, or a pool, other than the hardware resource.

Each of the hypervisors 135 and 145 is management software which allocates one or plural virtual machines to each of the physical machines and deploys the virtual machines. For example, multiple virtual machines including the virtual machines 0136 and 0137 is allocated to the physical machine P1 0130. Further, multiple virtual machines including the virtual machines 0146 and 0147 is allocated onto the physical machine P2 0140. In the allocating management of the virtual machine in the management table which has been already described, the virtual machine may be allocated to the hypervisor, instead of the physical machine.

The resource management program 0110 of the resource management server 0100 communicates with the hypervisors 0135 and 0145 of the physical machines P1 and P2 0130 and 0140 to exchange information so that the load information of the virtual machine or load information of the hypervisor (load information of a physical machine) is obtained at any time to update the physical machine information table 0200 and the VM information table 0400.

Further, the resource management server 0100 configures or updates the reservation information table 0300 based on the reservation information of the virtual machine which is input from a user who uses the virtual machine.

The virtual machines 0136 and 0137 operate on the hypervisor 0135. The hypervisor 0135 divides a computer resource of the physical machine p1 0130, for example, CPUs 0131 or memories 0132, and allocates each computer resource to each virtual machine. The hypervisor 0135 may dynamically change an amount of computer source which is allocated into each of the virtual machines. The hypervisor 0145 performs the same operation on the virtual machines 0146 and 0147. Since a guest OS operates on one virtual machine, the virtual machine may use a software application which operates in the guest OS.

A disk image 0151 of the virtual machine is stored in the shared storage 0150 which is connected to the physical machines P1 and P2 0130 and 0140. The disk image of the virtual machine is an image file which is stored in a virtual HDD which is provided in the virtual machine. The shared storage 0150 configures the virtual HDD and loads an operating system or an application which is stored in the virtual HDD in the memory 0132 (0142) to be executed. An entity of the VM disk image is the virtual HDD.

The hypervisor 0135 (0145) controls a VM disk image which is used in the virtual machine so that the virtual machine may treat the VM disk image as a virtual HDD. The VM disk image corresponds to one file which is actually stored in the HDD from a viewpoint of the hypervisor. One virtual machine requires one or more VM disk images. For example, the virtual machine 0147 on the physical machine P2 0140 uses one VM disk image 0151 which is stored in the HDD 0150.

The VM disk image 0151 is controlled by the hypervisor. The VM disk image is stored in the shared HDD 0150 which is connected to both the physical machines P1 and P2 0130 and 0140 so that if the resource management server 0100 changes a physical machine to which the operating system or the software application stored in the VM disk image is loaded, the physical machine in which the virtual machine operates may be changed, that is, the virtual machine may be moved between the multiple physical machines.

When the resource management server 0100 allows the virtual machine to be operated in other physical machine, a physical machine which is a migration source of the virtual machine copies the data which is loaded in the memory of the physical machine for the virtual machine and appropriately added, updated, or deleted, to the physical machine which is a migration destination of the virtual machine through the network. As described above, the physical machine in which the virtual machine is operated is changed by manipulation performed by the migration source physical machine which copies data of a memory used for a virtual machine to be migrated to a memory of the migration destination physical machine and manipulation performed by each of the hypervisors of both physical machines which changes the VM disk image in which data is loaded. The migration of the virtual machine starts when the resource management server 0100 instructs the hypervisors 0135 and 0145 of the migration source and migration destination physical machines to migrate the virtual machine.

In FIG. 1, even though both the physical machines P1 and P2 130 and 140 are connected to the shared HDD 150 in which the VM disk image is stored, if the VM disk image is copied through the network and a physical machine to which data of the VM disk image is loaded is changed, the HDD in which the VM disk image is stored does not need to be the shared HDD which is connected to both the physical machines P1 and P2 130 and 140, but the HDD may be an HDD which is individually connected to the physical machines P1 and P2 130 and 140.

Even though only the network 0120 is illustrated in FIG. 1, as a network which connects the physical machines, a network through which the resource management server 0100 obtains information from the physical machines P1 and P2 0130 and 0140 and a network which copies data between the physical machines P1 and P2 0130 and 0140 in order to migrate the virtual machine may be separately provided.

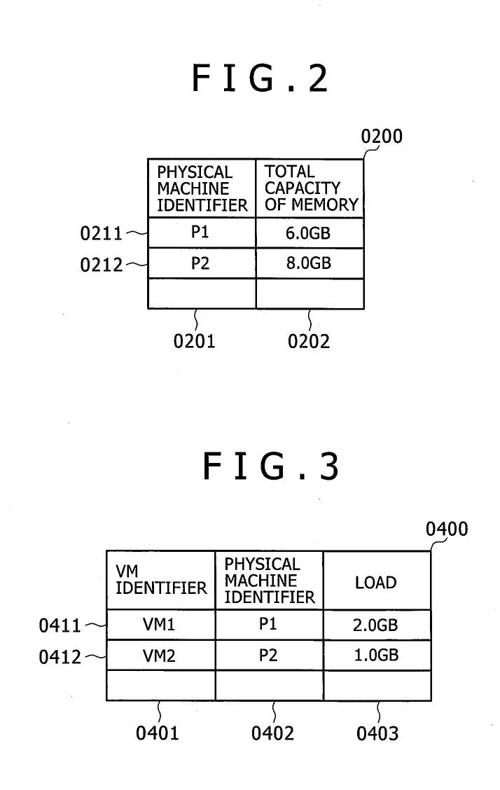

FIG. 2 illustrates an example of a physical machine information table 0200. The physical machine information table 0200 stores entire physical machines which may deploy the virtual machines in the computer system, such as the physical machine P1 0130 and the physical machine P2 0140 and a total resource amount of the machine which is allocated to the virtual machines from the physical machines. The physical machine information table 0200 allocates one row to one physical machine.

First, each of columns of the physical machine information table 0200 will be described. A physical machine identifier field 0201 stores identifiers for identifying the physical machines P1 and P2 0130 and 0140. A total memory capacity field 0202 stores a total resource amount of the machine which each of the physical machines allocates to the virtual machine. For example, a row 0211 indicates that a total capacity of a memory which is allocated to all virtual machines which operate on the physical machine P1 0130, from the memory 0132 of the physical machine P1 0130 is “6.0 GB”. Further, although as an example of a computer resource which is allocated to the virtual machine, the memory is exemplified, other resource which is allocated to the virtual machine, such as a CPU clock speed or a disk I/O or a combination of those may be used instead of the memory.

FIG. 3 illustrates an example of a VM information table 0400. The VM information table 0400 stores load information of the virtual machines 0136 and 0146 which operate on the physical machine P1 0130 and the physical machine P2 0140 which are included in the computer system. The load refers to a load which is applied from the virtual machine to the physical machine. The VM information table 0400 allocates one row to one virtual machine. Information on a virtual machine which does not operate may not be registered in this table.

A VM identifier field 0401 stores identifiers of virtual machines which operate on multiple physical machines included in the computer system. As illustrated in FIG. 1, identifiers which identify the virtual machines 0136 and 0146 which operate on the physical machines P1 and P2 0130 and 0140 are stored in the VM identifier field 0401.

A physical machine identifier field 0402 stores identifiers which identify the physical machines in which the virtual machines which are operating are deployed. This identifier is the same as the identifier which is stored in the physical machine identifier field 0201 of the physical machine information table 0200. In a row 0411, an identifier “P1” which identifiers the physical machine P1 0130 in which the virtual machine “VM1” operates is stored.

A load field 0403 stores a load of the virtual machine which is operating and which is collected from the hypervisors 0135 and 0145 by the resource management program 0110 by means of the measurement processing 0114. A value which is stored in the load field 0403 is, for example, a maximum value of multiple load information collected from the hypervisors 0135 and 0145 by the resource management server 0100 for a predetermined period of past time. The row 0411 indicates that the maximum value of a consumed amount of the memory of the virtual machine “VM1” in the predetermined period of past time, which is collected from the hypervisor 0135 by the resource management server 0100, is “2.0 GB”.

Further, as an example of a load of the virtual machine which is operating, even though the maximum value of the consumed amount of the memory of the virtual machine collected for the predetermined period of past time is exemplified, an average value of the consumed amount of the memory or a value obtained by adding a standard deviation to the average value may be used. Alternately, an estimated value of a load in a predetermined period of future time from the current time estimated based on a load measured for the predetermined period of past time may be used. Further, other resource which is allocated to the virtual machine, such as a CPU clock speed or a disk I/O or a combination of those may be used instead of the memory.

Even though a value which is stored in the load field 0403 is an absolute value, the value may be a relative value of a computer resource amount of the physical machine and a load of the collected virtual machine. Further, the value which is stored in the load field 0403 does not need to be information of one load, but may be a set of multiple load information of the virtual machines collected from the hypervisors 0135 and 0136 by the resource management server 0100 for the predetermined period of past time.

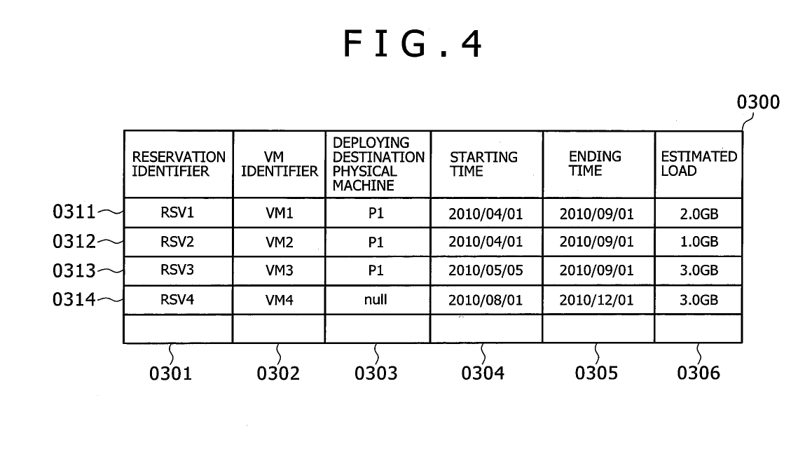

FIG. 4 is an example of a reservation information table 0300. This table 0300 stores information on an operation schedule of the virtual machine. A reservation identifier field 0301 stores an identifier which identifies reservation information to operate the virtual machine in a predetermined period of time.

A VM identifier field 0302 stores an identifier to identify a virtual machine which is operated by the reservation. This identifier is the same as the identifier which is stored in the virtual machine identifier field 0401 of the VM information table 0400. The identifier which is stored in the VM identifier field 0401 of the VM information table 0400 is necessarily present in the VM identifier field of the reservation information table 0300 and as a starting time of such reservation information, a time earlier than the current time is stored and as an ending time, a time later than the current time is stored. Further, if a disk image of a virtual machine which is identified by this identifier is completely created in the shared HDD 0150, an identifier of the virtual machine is stored.

If the disk image of the virtual machine identified by the identifier of the VM identifier field 0302 is not created, the resource management program 0110 stores an appropriate unique identifier and considers an identifier which is stored when the disk image of the virtual machine is created as the identifier of the virtual machine.

In a starting time field 0304, a time when a reserved virtual machine starts to operate and the resource is allocated from the physical machine thereto is stored. Further, in an ending time field 0305, a time when the virtual machine ends the operation and returns the resource to the physical machine is stored. For example, the reservation identifier “RSV1” of a row 0311 indicates that the virtual machine “VM1” is scheduled to operate from Apr. 1, 2010 to Sep. 1, 2010.

A deploying destination physical machine field 0303 stores an identifier which identifiers a physical machine in which, when the virtual machine starts to operate, the virtual machine is mounted to operate. This identifier is the same as the identifier which is stored in the physical machine identifier field 0201 of the physical machine information table 0200. For example, the row 0311 indicates that when the virtual machine VM1 starts to operate, the virtual machine VM1 operates on the physical machine P1 0130 and a computer resource is allocated to the virtual machine VM1 from the physical machine P1 0130. An identifier of the deploying destination physical machine field 0303 may be appropriately changed until the virtual machine starts to operate.

The physical machine in which the virtual machine operates does not need to be determined until the virtual machine starts to operate. If the physical machine is not determined, in the deploying destination physical machine field 0303, “null” may be stored (row 0314). Since the virtual machine which starts to operate may migrate between the multiple physical machines, after the virtual machine starts to operate, the combination of the VM identifier field 0302 and the deploying destination physical machine field 0303 of the reservation information table 0400 and the combination of the VM identifier field 0401 and the physical machine identifier field 0402 of the VM information table 0400 may be different from each other in some cases.

In an estimated load field 0306, an estimated value of the computer resource which is allocated from the physical machine to the virtual machine when the virtual machine operates is stored. A value which is stored in the estimated load field 0306 is for example, a value of a load of the virtual machine which is scheduled to operate which is estimated and input by the user of the virtual machine. Even though as the value which is stored in the estimated load field 0306, similarly to a value which is input in the load 0403 of the VM information table 0400, a consumed amount of the memory is exemplified as a load of the virtual machine, other resource which is allocated to the virtual machine, such as a CPU clock number or a disk I/O or a combination of those may be used instead of the memory.

Further, a value which is stored in the estimated load field 0306 may be a relative value with respect to a computer resource amount of the physical machine, other than an absolute value. The value which is stored in the estimated load field 0306 does not need to be one value, but may be a set of multiple values. For example, the value is 2.0 GB from 9 A.M. to 9 P.M. and 1.0 GB from 9 P.M. to 9 A.M.

For example, a row 0311 indicates that a virtual machine “VM1” operates on a physical machine “P1” since Apr. 1, 2010 and 2.0 GB of a total memory capacity of the physical machine “P1” is allocated thereto and 2.0 GB which is an allocated memory capacity is returned to the physical machine “P1” on Sep. 1, 2010.

If it is determined that an identifier stored in the VM identifier field 0302 of the reserved virtual machine is identical to an identifier of the virtual machine which is operating, the resource management program 0110 compares the starting time of the reserved virtual machine with the ending time of the virtual machine which is operating so that if the starting time is earlier than the ending time, the resource management program 0110 urges a manager to display an error at the time of inputting the reservation information or input a different value from the identifier of the virtual machine which is operating as a VM identifier of the virtual machine to be reserved.

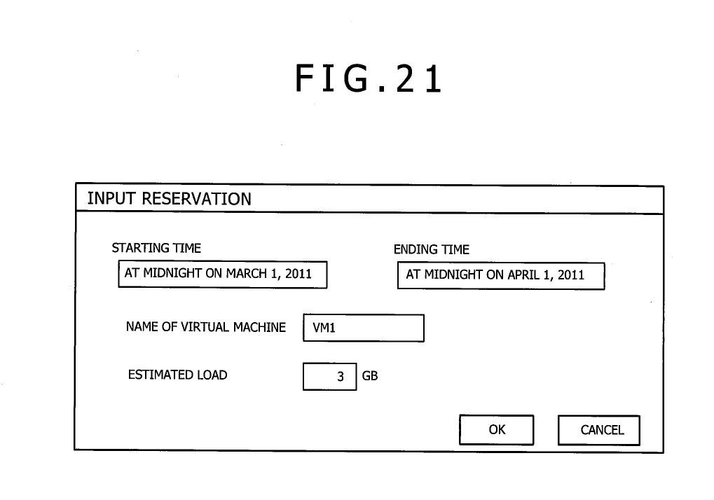

FIG. 21 illustrates a reservation information input screen of the virtual machine which is displayed on the display 0106 by the resource management program 0110 through the output I/F. If the virtual machine is necessarily intended to operate on a specific physical machine, the deploying destination physical machine of the virtual machine may be designated through the reservation information input screen.

Referring to FIG. 4, even though it is described that an arrangement destination of the virtual machine is the physical machine, but the deploying destination may be the hypervisor. The user may group multiple hypervisors so that the resource group may be the deploying destination of the virtual machine. By grouping the hypervisors, a range of the physical machine in which the virtual machines are optimally arranged may be restricted.

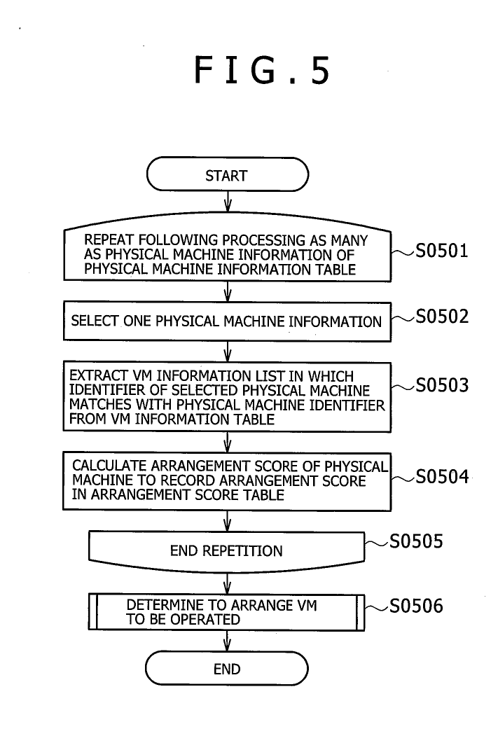

Next, a processing for achieving an optimal arrangement when arranging the virtual machine which is scheduled to operate in the physical machine will be described. FIG. 5 is a flowchart for performing the processing. The resource management program 0110 executes the flowchart of FIG. 5.

“Optimization” refers to arrangement of the virtual machine in accordance with a “policy”. The policy is configured in the resource management program 0110 as a policy file by a managing user. As an example of the policy, as described above, the multiple virtual machines may be arranged in the multiple physical machines so as to equalize the loads of the virtual machines between the multiple physical machines. The loads may be equalized not only based on the load value which is applied to the physical machines by the virtual machines, but also based on an available capacity of the computer resource of the physical machine. As other policy, from a viewpoint of lower power consumption of the computer system, the multiple virtual machines is concentrated in a part of physical machines to reduce the power consumption of other physical machines. Further, as still other policy, from a viewpoint of ensuring reliability of the computer system, the virtual machines may be deployed in the multiple physical machines which are spaced apart from each other with a predetermined interval or more.

Next, a flowchart of FIG. 5 will be described in detail. First, the resource management program 0110 executes step S0501 at an arbitrary time. The arbitrary time refers to, for example, a time which is set in the resource management server 0100 by a user. Step S0501 is executed by the arrangement calculation processing 0112 and processings to step S0504 are repeatedly performed until all information of the multiple physical machines stored in the physical machine information table 0200 of FIG. 2 is referred to.

In step S0502, one of referred physical machine information is selected. Specifically, one of the physical machine information stored in the physical machine information table 0200 is selected and data for one row of the physical machine information table 0200 is stored in the memory 0102.

In step S0503, referring to the VM information table 0400 of FIG. 3, all VM information indicating that an identifier of the physical machine identifier field 0201 of the physical machine information selected in step S0502 matches with an identifier in the physical machine identifier field 0402 is extracted from the VM information table 0400.

In step S0504, an arrangement score of the physical machine is calculated using a value of the total memory capacity field 0202 of the physical machine information selected in step S0502 and a value in the load field 0403 of the entire VM information extracted in step S0503 and recorded in an arrangement score table 0600.

The arrangement score is a value relating to a height of a priority to deploy the virtual machines in each of the physical machines in order to achieve the optimal arrangement of the virtual machines. It is determined that as the value of the arrangement score of the physical machine becomes large, the priority to mount the virtual machine is high. For example, as an index to optimally arrange the virtual machines in the physical machine, the resource management server 0100 selects to equalize available memory of the multiple physical machines included in the computer system between the multiple physical machines. From this viewpoint, a physical machine having a larger available memory is appropriate to arranging the virtual machine which is scheduled to operate therein. Therefore, the available memory of the physical machine becomes the arrangement score of the physical machine.

As illustrated in FIGS. 2 and 3, if the physical machine information selected in step S0502 is the row 0211, the physical machine identifier field 0201 is “P1” and a value stored in the total memory capacity field is “6.0 GB”. Therefore, the VM information extracted from the VM information table 0400 in step S0503 is a row 0411 in which the identifier in the physical machine identifier field 0402 matches with “P1”. Since a value stored in the load field 0403 of the row 0411 is “2.0 GB”, the available memory of the physical machine “P1” is “6.0−2.0=4.0 GB”. As a result, the arrangement score of the physical machine “P1” is 4.0.

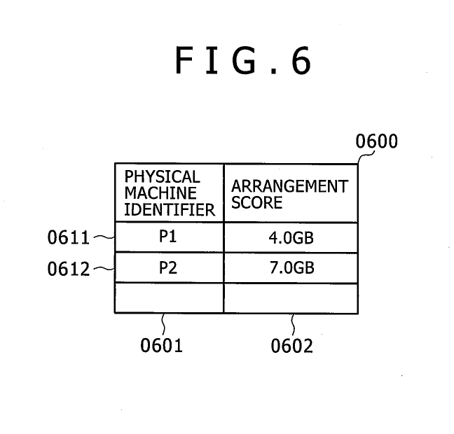

Data recorded in the arrangement score table 0600 in step S0504 is illustrated in FIG. 6. The arrangement score table 0600 includes a physical machine identifier field 0601 and an arrangement score field 0602. In the physical machine identifier field 0601, an identifier of the physical machine identifier field 0201 of the physical machine information 0200 selected in step S0502 is stored. In the arrangement score field 0602, the arrangement score of each of the physical machines calculated in step S0504 is stored. In the example illustrated in FIGS. 2 and 3, as described above, the arrangement score of the physical machine “P1” is “4.0” so that in the arrangement score table 0600, as illustrated in the row 0611, an identifier “P1” is stored in the physical machine identifier field 0601 and an arrangement score “4.0” is stored in the arrangement score field 0602.

Step S0505 of FIG. 5 is a termination step corresponding to step S0501 which is a beginning step of repetitive steps and steps S0502 to S0504 are repeatedly performed until the entire physical machine information stored in the physical machine information table 0200 is referred to.

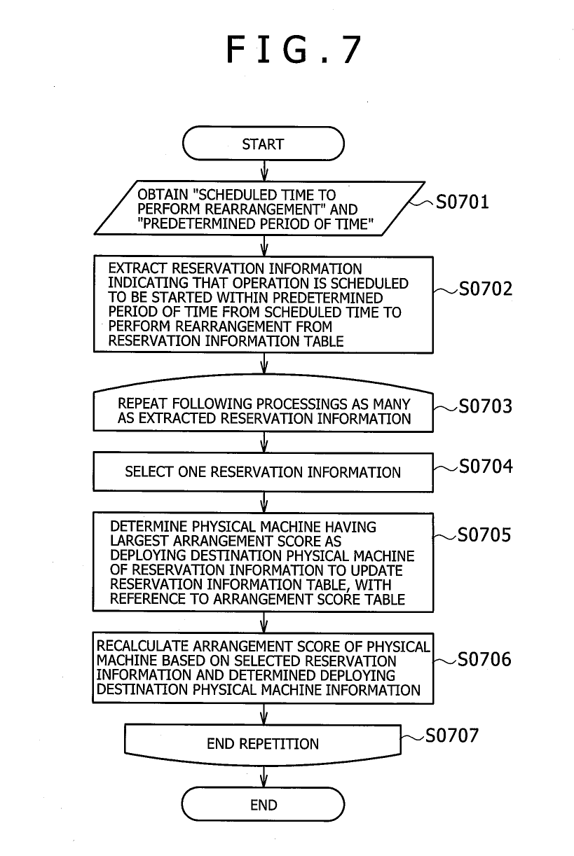

In step S0506, based on the information stored in the arrangement score table 0600 of FIG. 6 and the reservation information table 0300 of FIG. 4, the identifier of the physical machine stored in the deploying destination physical machine field 0303 of the reservation information table 0300 is read to determine a physical machine which allocates the computer resource to the virtual machine which is scheduled to operate. Details of step S0506 is illustrated in the following flowchart of FIG. 7.

FIG. 7 is a flowchart which accomplishes a processing (step S0506 of FIG. 5) for determining a physical machine of a destination of arranging the virtual machine which is scheduled to operate. This flowchart is an example of a processing for determining a physical machine to allow optimal arrangement of the virtual machine which is scheduled to operate among the multiple physical machines, for every “predetermined period of time” from a “scheduled time”, that is, a starting time when the management server 0110 arranges (or rearranges) the virtual machine in the multiple physical machines present in the computer system.

In step S0701, the resource management server 0100 obtains information of “(rearrangement) scheduled time” and “the predetermined period of time” by the input from the managing user. The “schedule time” may be an arbitrary time after a time when the processing of FIG. 5 is completed. The “predetermined period of time” refers to a predetermined period of time from the “scheduled time” to a next “scheduled time”, and for example, one week or one month.

In step S0702, all reservation information of rows whose time stored in the starting time field 0304 is within a predetermined period of time from the “scheduled time” is extracted referring to the reservation information table 0300 of FIG. 4. For example, if the resource management program 0110 obtains “midnight on May 1, 2010” as a “scheduled time” and “one month” as the predetermined period of time in step S0701, in step 0702, a row 0313 whose time stored in the starting time field 0304 is from the midnight on May 1, 2010 to May 31, 2010 is extracted referring to the reservation information table 0300 of FIG. 4.

In step S0703, the processings to step S0707 are repeatedly performed until all reservation information extracted in step S0702 is referred to. In step S0704, one of extracted reservation information is selected.

In step S0705, an arrangement of the virtual machines which are scheduled to operate is determined based on the arrangement score table 0600 illustrated in FIG. 6 and the deploying destination physical machine field of the reservation information table is updated based on the result of the determination. Specifically, the reservation information table is updated such that the identifier in the deploying destination physical machine field of the reservation information selected in step S0703 becomes an identifier of a physical machine having the highest score in the arrangement score table 0600.

If the management program 0110 refers to the arrangement score field 0602 of the arrangement score table 0600 (FIG. 6), a row having the highest arrangement score is a row 0612. If the reservation information selected in step S0704 is a row 0313 of the reservation information table 0300 (FIG. 4), the physical machine “P2” indicated by the physical machine identifier field 0601 is determined as the physical machine in which virtual machine “VM3” which is scheduled to operated and indicated by the VM identifier field 0302 is arranged and operated. Even though the deploying destination physical machine field 0303 of the row 0313 is denoted by “P1”, the management program 0110 updates the deploying destination physical machine field 0303 to an identifier “P2”. Further, even when the deploying destination physical machine field 0303 of the row 0313 is “null”, the deploying destination physical machine field 0303 is updated to the identifier “P2”.

In step S0706, an arrangement score of the physical machine is recalculated on the assumption that a load displayed in the estimated load field 0306 is allocated as the computer resource from the physical machine determined in step S0705 to the virtual machine which is scheduled to operate indicated by the VM identifier 0302 of the reservation information selected in step S0704 and the recalculated arrangement score is updated and stored in the arrangement score table 0600.

Referring to FIGS. 4 and 6, a physical machine in which the virtual machine which is scheduled to operate operates, determined in step S0705, is “P2”. Further, if the reservation information selected in step S0704 is the row 0313 of the reservation information table 0300, a value of the arrangement score field 0602 of a row 0612 which indicates the arrangement score of the physical machine “P2” in the arrangement score table 0600 before being updated is “7.0”. The VM identifier field 0302 of the row 0313 is “VM3”, and the estimated load field 0306 is “3.0 GB”. Therefore, if a virtual machine “VM3” is newly allocated, the available memory of the physical machine “P2” is 4.0 GB (7.0 GB−3.0 GB) so that a value of the arrangement score field 0602 of the row 0612 of the arrangement score table 0600 is updated to 4.0 GB.

Step S0707 is a termination step corresponding to step S0703 which is a beginning step of repetitive steps. The management program 0110 repeatedly performs the above steps to step S0707 until all reservation information extracted in step S0702 is referred to.

Further, if the estimated load exceeds the highest arrangement score, the resource management program 0110 displays that a virtual machine to be scheduled to operate cannot be arranged in the physical machine.

By the processings illustrated in the flowchart of FIGS. 5 and 7, the management program 0110 deploys a virtual machine which is identified by the VM identifier field 0302 in a physical machine identified by an identifier stored in the deploying destination physical machine field 0303 of the reservation information table 0300 as the deployment processing 0115 (FIG. 1) at a time stored in the starting time field 0304 of the reservation information table 0800C. By doing this, the optimal arrangement of the virtual machines which are scheduled to operate is established.

That is, if it is specifically described with reference to FIGS. 2, 3, and 4, the resource management server 0100 achieves the optimal arrangement of the virtual machines in which the identifier of the deploying destination physical machine field of the row 0313 of the reservation information table 0300 is changed from the physical machine “P1” to the physical machine “P2” and the virtual machine “VM3” starts to operate on the physical machine “P2” from May 5, 2010 so that the available memory of the physical machine “P1” and the physical machine “P2” become 4.0 GB between May 5, 2010 and Sep. 1, 2010 to equalize free spaces of the multiple physical machines included in the computer system.

Further, if the number of rows of the reservation information table 0300 is n, the number of orders of determining the arrangement of the virtual machines when the repetitive processings of step S0703 to step S0707 of FIG. 7 determines the arrangement of the virtual machines is a factorial of n. Therefore, in the processings of FIG. 7, the determination processing of the arrangement of the virtual machines is performed while fixing the order of determining the arrangement of the virtual machines to one. However, the processings of FIG. 7 is changed such that the determination processing of the arrangement of the virtual machines is repeatedly performed in m orders (m factorial of n) and a standard deviation of an amount of available resource of the entire physical machines in the arrangement of the virtual machines which are scheduled to operate, which is determined in each of the orders is stored so as to adopt an arrangement of the virtual machines which are scheduled to operate, included in a pattern having the smallest standard deviation.

As described above, the computer system in the above-described embodiment adjusts a load balance of the multiple physical machines in which multiple virtual machines is mounted at the time of determining the optimal arrangement of the multiple virtual machines together with a virtual machine which does not currently operate, but is scheduled to operate so that when the virtual machine which is scheduled to operate actually operates, it is possible to optimally adjust the load balance of entire system without repeating the optimal arrangement processing of the multiple virtual machines at a time when the virtual machine which is scheduled to operate actually operates.

Further, the optimal arrangement processing of the multiple virtual machines is implemented without migrating the virtual machine which is operating based on the load of the virtual machine which is operating and a total amount of computer resource which may be allocated by the physical machine to the virtual machine so that it is possible to prevent the increase of a load which is applied to the network due to the migration of the virtual machines between the multiple physical machines.

If the virtual machine which is mounted in the physical machine to be operating is migrated between the multiple physical machines, the information in a memory which is allocated to the virtual machine is copied from a migration source physical machine to a migration destination physical machine and a new virtual machine is created in the migration destination physical machine, based on copied information, to stop a virtual machine which is a copying source. In this case, if the information in a memory of the copying source is updated before completing the copying, the migration source physical machine needs to copy the updated information to the migration destination physical machine again. Therefore, if there are lots of information amount to be copied, it requires long time to migrate the virtual machine. However, the computer system according to the above-described embodiment does not accompany the migration of the virtual machine which is operating, so that the above problems may be cleared.

Further, the management server mounts the virtual machines which are scheduled to operate in the entire physical machines included in the computer system so as to achieve the optimal arrangement of the virtual machines. However, the management server may restrict the physical machines in which the virtual machines which are scheduled to operate may be arranged. Such physical machines may be registered in a reservation screen (FIG. 21). However, in the reservation screen, if a virtual machine needs to be arranged in a specific physical machine but may not be a target of the optimal arrangement, a combination of this virtual machine and the physical machine may be registered in the reservation screen by the managing user.

In the above-described embodiment, even though it is described that a starting momentum of the optimal arrangement of the multiple virtual servers regularly occurs, the starting momentum may be a manual momentum, addition of a reservation, change of the reservation (a starting time, an ending time, or a load), deletion of the reservation, or deletion of a virtual machine.

In step S0701 of FIG. 7, it is described that the “predetermined period of time” is one month, which is an example. If the “predetermined period of time” is long, the “optimal arrangement” is not achieved for a long time until the virtual machine which is scheduled to operate starts to operate. In contrast, if the period of time is short, the rearrangement processing of the virtual machine is frequently performed. Therefore, the “predetermined period of time” is set to be in an appropriate range for operation of the computer system.

Next, a second embodiment of the present invention will be described. A difference of this embodiment from the first embodiment which has been described above is that the management server sets a target value for the load in each of the physical machines included in the computer system and if the target value cannot be reached only by optimally arranging the virtual machines which are scheduled to operate, when the optimal arrangement of the virtual machines which are scheduled to operate is implemented, the virtual machines which are operating are rearranged, that is, the virtual machines which are operating are migrated to reach the target value. However, the computer according to this embodiment reduces the frequency or the number of migration of the virtual machines which are operating as many as possible, as follows.

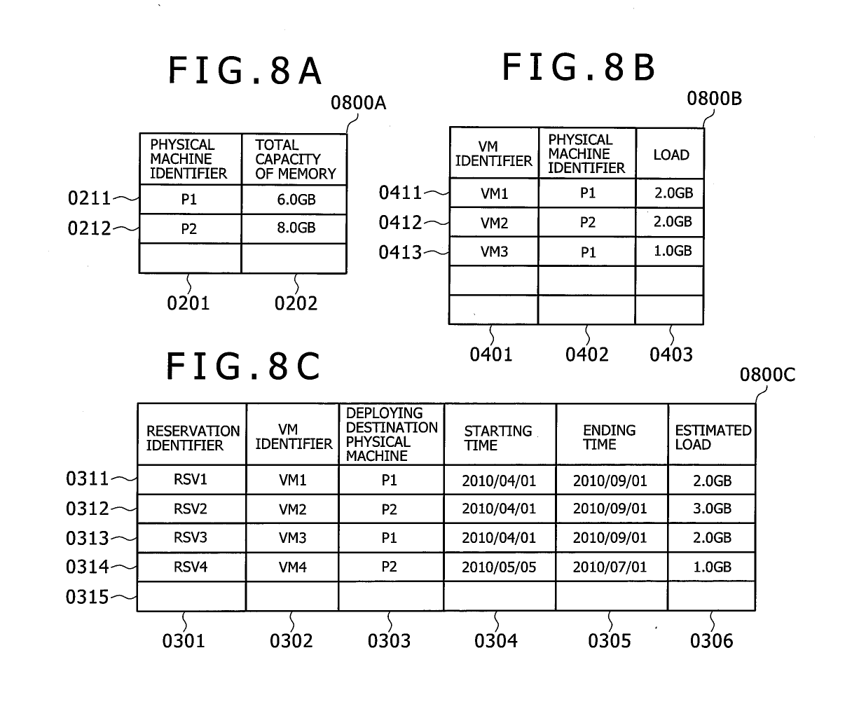

FIGS. 8A to 8C illustrate a physical machine information table 0800A (FIG. 8A), a VM information table 0800B (FIG. 8B), and a reservation information table 0800C (FIG. 8C) of the second embodiment. The physical machine information table 0800A has the same structure as the physical machine information table 0200 of the first embodiment. The VM information table 0800B has the same structure as the VM information table 0400 of the first embodiment. The reservation information table 0800C has the same structure as the reservation information table 0300 of the first embodiment. However, data registered in the management table of the first embodiment may be different from data registered in the management table illustrated in FIGS. 8A to 8B in some cases.

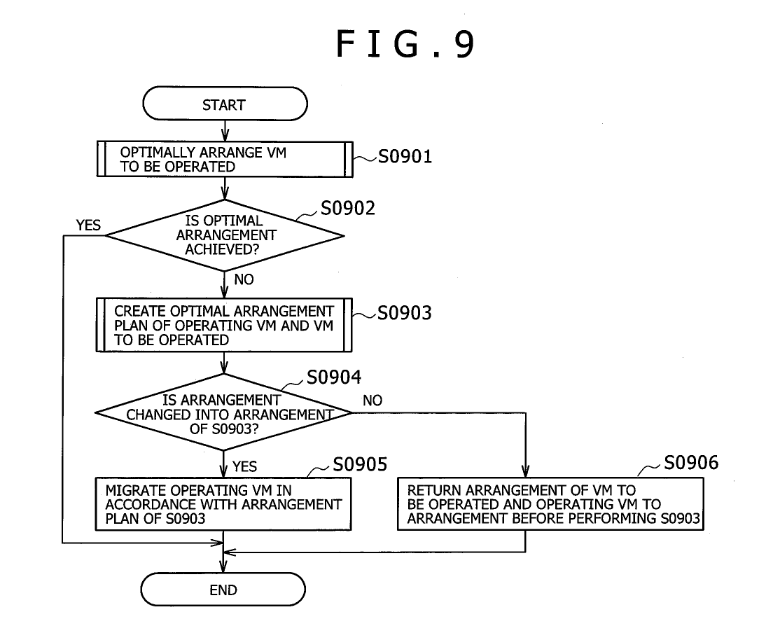

FIG. 9 illustrates a flowchart of a processing for optimally arranging virtual machines in multiple physical machines according to the second embodiment. The resource management program 0110 illustrated in FIG. 1 executes the flowchart of FIG. 9.

The processing illustrated in FIG. 9 is to determine whether to maintain the optimal arrangement of multiple virtual machines present in the computer system together with virtual machines which are operating, based on an assumption of the determined optimal arrangement of the virtual machines which are scheduled to operate in accordance with the flowcharts of FIGS. 5 and 7. If the determination is affirmed, the resource management program 0110 ends the arrangement processing of the virtual machines and in contrast, if the determination is denied, the arrangement of not only the virtual machines which are scheduled to operate and but also the virtual machines which are operating, in the multiple physical machines, is changed.

Next, a flowchart of FIG. 9 will be specifically described. The resource management program 0110 performs the optimal arrangement processing of the virtual machines which are scheduled to operate in accordance with step S0901 at an arbitrary time set by a user of the resource management server 0100. Step S0901 is equivalent to the flowcharts of FIGS. 5 and 7, which have been already described.

In step S0902, it is determined whether it is possible to achieve an object in the optimal arrangement of the virtual machines, for example, to improve the balance of the load between the multiple physical machines, only by arranging the virtual machines which are scheduled to operate in a target physical machine, determined in step S0901. If the determination is affirmed in step S0902, the processing for optimal arrangement of the virtual machines ends.

Thereafter, the deployment processing 0115 (FIG. 1) sets a scheduled virtual machine identified by an identifier stored in the VM identifier field 0302 in a physical machine identified by an identifier stored in the deploying destination physical machine field 0303 of the reservation information table 0800C (FIG. 8C) at a time stored in the starting time field 0304. However, if it is determined in step S0902 that the object of the optimal arrangement of the virtual machine cannot be achieved, the processing of step S0903 is performed.

A target value of the optimal arrangement of the virtual machines in order to equalize available memory between the multiple physical machines included in the computer system is exemplified as follows. In step S0701 of FIG. 7, within the “predetermined period of time” (for example, one month) from a “scheduled time” (for example, at midnight on May 1, 2010), a difference of an average value of available memory of the entire physical machines and available memory of each of the physical machines becomes less than 0.5 GB in the entire physical machines. Further, the status of each of the tables illustrated in FIGS. 8A to 8C are status after performing step S0901.

For example, if the current time is May 2, 2010, FIGS. 8A to 8C illustrate that a virtual machine “VM1” having a load of “2.0 GB” and a virtual machine “VM3” having a load of “1.0 GB” operate on a physical machine “P1” and a total memory capacity of the physical machine “P1” is “6.0 GB”. In this case, the available memory of the physical machine “P1” is “6.0−2.0−1.0=3.0 GB”.

On a physical machine “P2”, a virtual machine “VM2” having a load of “2.0 GB” is operating and a virtual machine “VM4” which will start to operate at May 5, 2010 which is within the predetermined period of time (one month) from a rearrangement time (at midnight on May 1, 2010) is scheduled to operate with an estimated load of “1.0 GB”. The total memory capacity of the physical machine “P2” is “8.0 GB”. Therefore, the available memory of the physical machine “P2” becomes “8.0−2.0−1.0=5.0 GB” on May 5, 2010. Therefore, an average of the available memory of the physical machine “P1” and the physical machine “P2” is “(3.0+5.0)÷2=4.0 GB” and an object that “the difference of the average value of the available memory of the entire physical machines and the available memory of each of the physical machines is less than 0.5 GB in the entire physical machines” may not be achieved. Therefore, step S0903 is performed.

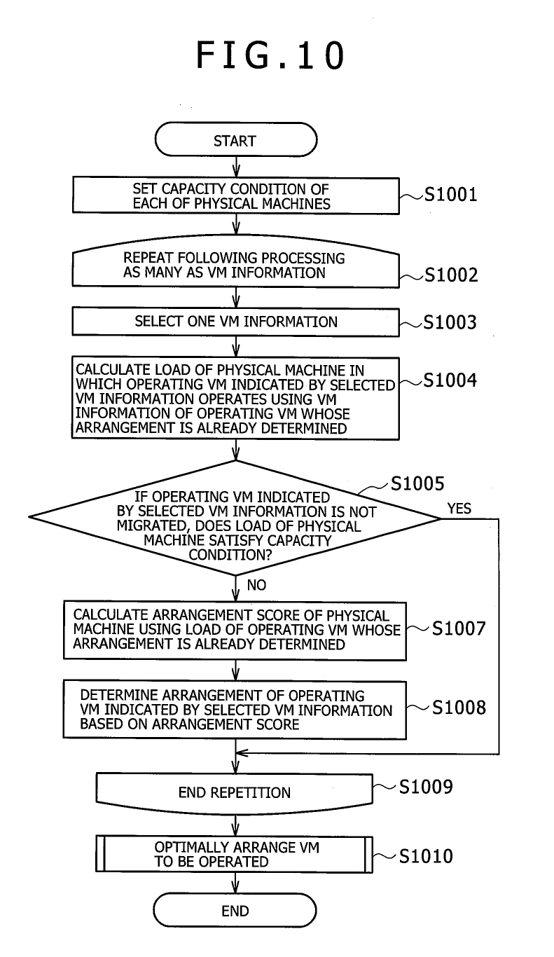

In step S0903, an operation processing to determine the optimal arrangement of the multiple virtual machines including the virtual machines which are operating and virtual machines which are scheduled to operate is performed. In this case, the number of virtual machines which are operating, which are migrated between the multiple physical machines needs to be reduced. The resource management program 0110 changes the identifier of the physical machine identifier 0402 of the VM information table 0800B to an identifier of the migration destination physical machine, with respect to the virtual machine which is operating, to be migrated to other physical machine, based on the operation result. Further, with respect to the virtual machines which are scheduled to operate, the resource management program 0110 changes the identifier of the deploying destination physical machine field 0303 of the reservation information table 0800C to an identifier of the deploying destination physical machine of the virtual machine which is scheduled to operate redetermined in step S0903. A detailed flowchart of step S0903 will be described below with reference to FIG. 10.

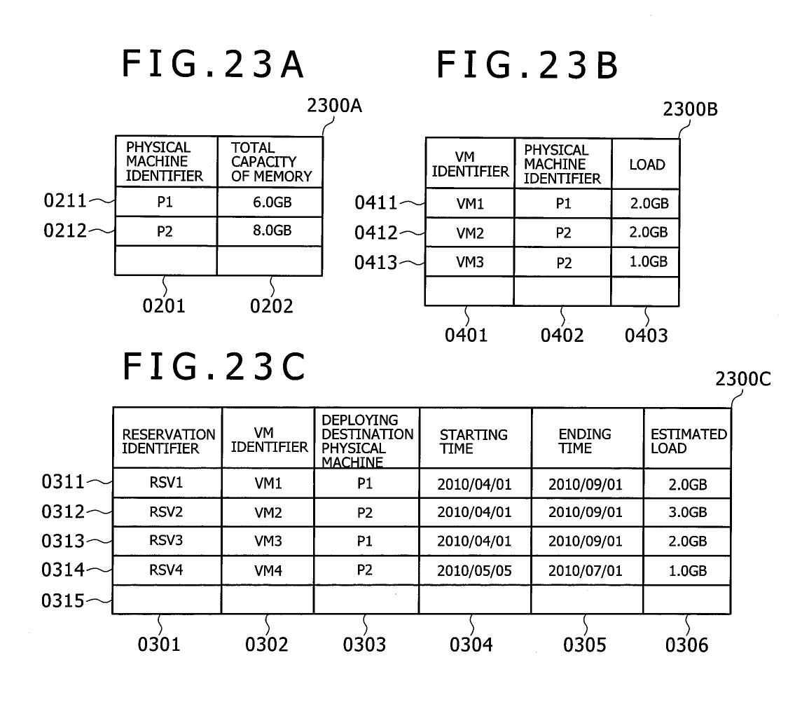

FIG. 23 illustrates a management table corresponding to an arrangement form of multiple virtual machines obtained by the optimal arrangement processing of the virtual machine. FIG. 23A is a physical machine configuration table, FIG. 23B is a VM information table in accordance with the virtual machines after being optimally arranged, and FIG. 23C is a reservation information table of the virtual machines which are scheduled to operate after being optimally arranged. When comparing with the management table of FIG. 8, it is understood that the virtual machine VM3 which is currently operating is migrated from a physical machine identified as P1 to a physical machine identified as P2.

In step S0904, it is determined whether to change the arrangement of the virtual machines in the computer system to an arrangement of the virtual machines determined in step S0903. In other words, the management program 0110 compares the arrangement form of the virtual machines determined in step S0901 with the arrangement form of the virtual machines determined in step S0903 to determine whether the arrangement determined in step S0903 is closer to the target. If the arrangement determined in step S0903 is closer to the optimal arrangement target of the virtual machines, the processing migrates to step S0905. If the arrangement determined in step S0901 is closer to the optimal arrangement target of the virtual machines, the processing migrates to step S0906. In step S0906, the arrangement of the virtual machines which are scheduled to operate and the arrangement of the virtual machines which are operating are returned to the state before performing step S0903.

Step S0904 has an object to “arrange multiple virtual machines in order to equalize available memory of entire physical machines included in the computer system”. Therefore, a standard deviation of the available memory of the entire physical machines after optimally arranging the virtual machines which are scheduled to operate without accompanying the rearrangement of the virtual machines which are operating determined in step S0901 is compared with a standard deviation of the available memory of the entire physical machines in a status where the rearrangement of the virtual machines which are operating is allowed, determined in step S0903. If the latter standard deviation is smaller than the former standard deviation, the processing of step S0905 is performed and otherwise, the processing of step S0906 is performed. If both standard deviations are equal to each other, the processing of any one of steps S0905 and S0906 is performed.

Further, in step S0904, the management program 0110 compares the arrangement of the virtual machines determined in step S0901 with the arrangement of the virtual machines determined in step S0903. However, the management program 0110 may determine whether the arrangement of the virtual machines determined in step S0903 achieves the object for the optimal arrangement of the virtual machines, which is similarly to step S0902.

In step S0905, the VM migration processing 0113 (FIG. 1) of the resource management program 0110 is performed to migrate the virtual machines which are operating so as to implement the arrangement of the virtual machines determined in step S0903. This migration processing starts at a “scheduled time to perform rearrangement” obtained in step S0701.

In step S0906, the physical machine identifier field 0402 of the VM information table 0800B and the deploying destination physical machine field 0303 of the reservation information table 0800C which are changed in step S0903 are returned to a state before performing step S0903.

FIG. 10 is a flowchart illustrating a processing of creating a plan for optimally arranging the virtual machines which are operating and the virtual machines which are scheduled to operate in the physical machines, which is performed in step S0903 of FIG. 9. This flowchart is executed by the resource management program 0110.

In step S1001, a boundary condition for each of the physical machines in order to achieve the optimal arrangement of the virtual machines, for example, a “capacity condition” is determined. The “capacity condition” is an index regarding a capacity of the memory of the physical machine which is considered by the resource management program 0110 when it is determined whether to change the arrangement of the virtual machines which are operating in each of the physical machines.

The resource management program 0110 sets the capacity condition, for example, that a available capacity of each of the physical machines is equal to or higher than an average value of available capacities of the entire physical machines within a predetermined period of time from a time when the rearrangement of the multiple virtual machines is performed, in order to equalize the available capacity of each of the memories of the multiple physical machines.

In the example illustrated in FIG. 8, similarly to step S0902, since the average of the available capacities of the entire physical machines is 4.0 GB within a predetermined period of time from a rearrangement performing time, the capacity condition of each of the physical machines is that “an available capacity is 4.0 GB or more”. If the virtual machine which is operating is not migrated, only when the above condition is not satisfied, the resource management program determines a physical machine which becomes a migration destination of the virtual machine which is operating based on the arrangement score.

In step S1002, processings to step S1009 are repeatedly performed until all the virtual machine information stored in the VM information table 0800B is referred to. In step S1003, one of VM information to be referred is selected.

In step S1004, a load of the physical machine in which the virtual machine selected in step S1003 operates is calculated using the VM information of the virtual machines which are operating and whose arrangement is already determined in the repetitive processing steps S1002 to S1009.

For example, the processings of steps S1002 to S1009 are performed twice, so that the virtual machine whose VM identifier of the VM information table 0800B is “VM1” is determined to be arranged in the physical machine “P1” and the virtual machine whose VM identifier of the VM information table 0800B is “VM2” is determined to be arranged in the physical machine “P2” and the identifiers “P1” and “P2” of the physical machines are stored in the physical machine identifier field 0402 of the VM information table 0800B. For example, the virtual machine which is operating, selected from the VM information table 0800B in step S1003 is a virtual machine whose VM identifier is identified as “VM3”.

A physical machine in which “VM3” operates is the physical machine “P1” which is identified in the physical machine identifier field 0402 of the row 0413. In the physical machine “P1”, the virtual machine “VM1” is determined to be arranged. When the load field 0403 of the row 0411 of the VM information table 0800B is referred, the load is “2.0 GB”. Therefore, the load of the physical machine “P1” in step S1004 is 2.0 GB.

Step S1005 is a step which determines whether the load of the physical machine in which the selected virtual machine is currently operating satisfies the capacity condition set in step S1001 when the virtual machine which are operating, selected in step S1003 is not migrated from the current physical machine to other physical machine. If the capacity condition is not satisfied, the processing of step S1007 is performed, otherwise, the processing of step S1009 is performed.

For example, in step S1001, “an available capacityof each of the physical machines is equal to or higher than 4.0 GB” is set as the capacity condition and the virtual machine, which is operating, selected from the VM information table 0800B in step S1003 is considered as a virtual machine whose VM identifier is identified as “VM3”.

The total memory capacity of the physical machine “P1” in which “VM3” is mounted is 6.0 GB as represented in the total memory capacity field 0202 according to the physical machine information table 0800A and a load of the virtual machine “VM3” is 1.0 GB according to the load field 0403 of the VM information table 0800B. In step S1004, a calculated load of the physical machine “P1” is 2.0 GB. If the virtual machine “VM3” is not migrated from this physical machine to other physical machine, the available memory of the physical machine “P1” is 6.0−2.0−1.0=3.0 GB, which is below the capacity condition “an available capacity of the memory is equal to or higher than 4.0 GB”. Therefore, the processing of step S1007 is performed.

In step S1007, the arrangement scores of the multiple physical machines are determined using the load of the virtual machines which are operating, whose arrangement in the physical machine is already determined by the repetitive processings of steps S1002 to S1009. A method of considering the arrangement score is similar to step S0504 of FIG. 5, which has been already described.

In step S1008, other physical machine to which the virtual machine selected in step S1003 is migrated from a physical machine in which the virtual machine is currently mounted and in which the virtual machine is mounted is determined based on the arrangement score calculated in step S1007 and an identifier of the previously mentioned other physical machine is stored in the physical machine identifier field 0402 of a row in which the selected virtual machine is present in the VM information table 0800B.

For example, similarly to the first embodiment, available memory becomes the arrangement score of each of the physical machines. Here, when step S1007 is performed, the repetitive processings of steps S1002 to S1009 are already performed twice, so that the virtual machine whose VM identifier of the VM information table 0800B is identified as “VM1” is determined to be arranged in the physical machine “P1” and the virtual machine whose VM identifier of the VM information table 0800B is identified as “VM2” is determined to be arranged in the physical machine “P2” and the identifiers “P1” and “P2” of the physical machines are stored in the physical machine identifier field 0402 of the VM information table 0800B.

When it is described with reference to FIGS. 8A to 8C, the available memory of the physical machine “P1” is 6.0 GB (total memory capacity)−2.0 GB (load of virtual machine)=4.0 GB and the available memory of the physical machine “P2” is 8.0−2.0=6.0 and arrangement scores of those are 4.0 and 6.0, respectively. Therefore, in step S1008, the virtual machine VM3 selected in step S1003 is determined to be arranged in the physical machine “P2” having the highest arrangement score and the identifier in the physical machine identifier field 0402 of the row 0413 indicating the virtual machine VM3 of the VM information table 0800B is changed from “P1” to “P2” to be registered.

Further, if the physical machine in which the virtual machine selected in step S1003 is operating has the highest arrangement score, the virtual machine is not migrated to other machines. However, in the flowchart (S0903) of FIG. 10, the determination of step S0902 is denied so that the at least one virtual machine which is operating is migrated from the machine in which the virtual machine is currently operating to other physical machine having the most available resource capacity.

Step S1009 is a termination step corresponding to step S1002 which is a beginning step of repetitive steps. Steps S1002 to S1009 are repeatedly performed until the resource management program 0110 refers to all the virtual machine information stored in the VM information table 0800B.

Step S1010 is a step of rearranging the virtual machines which are scheduled to operate based on the arrangement of the virtual machines which are operating, determined in steps S1002 to S1009, which is similar to the flowchart of FIG. 5.

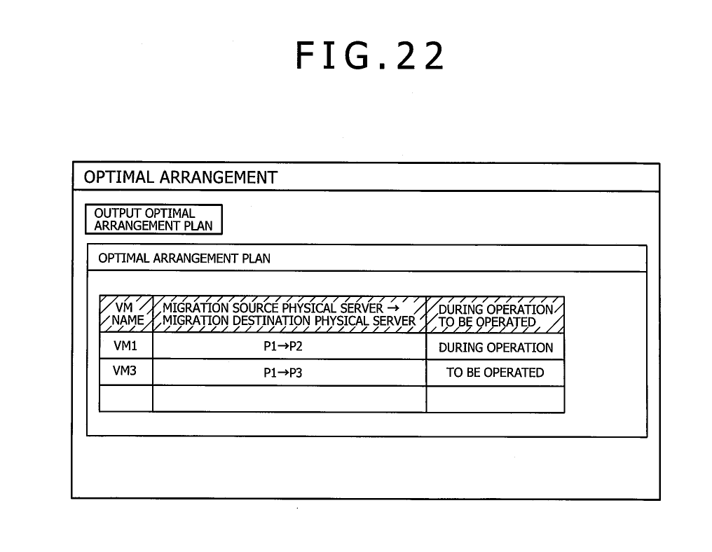

FIG. 22 is an input screen corresponding to step S0903 (flowchart of FIG. 10). If the managing user requests the input screen to output the optimal arrangement plan of the virtual machines which are operating, including the virtual machines which are scheduled to operate, step S0903 continuously performs the optimal arrangement plan creating processing.

FIG. 22 illustrates that the migration of the virtual machine VM1 which is operating in the physical machine P1 to other physical machine P2, the migration of the virtual machine VM3 which is scheduled to operate from the initially scheduled physical machine P1 to other physical machine P3 are output as an optimal arrangement. Further, the latter is an optimal arrangement determined by step S1010.

FIG. 10 illustrates an example of a method of simultaneously determining the optimal arrangement of the virtual machine which is operating and the optimal arrangement of the virtual machine which is scheduled to operate. If the number of rows of the VM information table 0800B is n, the number of orders of determining the arrangement when the resource management program 0110 determines the arrangement of the virtual machines by repeating steps S1002 to step S1009 of FIG. 10 is a factorial of n. In FIG. 10, even though it is described that the number of orders for determining the arrangement of the virtual machines is one, the resource management program 0110 reviews the arrangement pattern of the virtual machines in the m orders (m≧factorial of n) to determine the arrangement of a pattern having the smallest standard deviation of the available capacity of the entire physical machines as the optimal arrangement.

As described above, the resource management program 0110 determines the arrangement of the virtual machines which are scheduled to operate in order to achieve the optimal arrangement of the virtual machines for every predetermined period of time from a scheduled time. However, if the target in the optimal arrangement of the multiple virtual machines including the virtual machines which are operating cannot be achieved by the above-described method, the virtual machines which are operating are migrated so that the optimal arrangement of the entire of the multiple virtual machines is achieved.

In this case, if the above-described capacity condition is not satisfied, the resource management program 0110 changes the arrangement of the virtual machines which are operating to reduce the frequency and the number of migration of the virtual machines which are operating. By doing this, the resource management program shortens the time required to migrate the virtual machines which need to be migrated so that the performance of the multiple virtual machines in the computer system is stably maintained.

Further, in the above-described embodiment, the resource management program may put a restriction on the physical machine to which the virtual machine which is operating and/or scheduled to operate is migrated. Further, the resource management program may calculate a standard deviation of the available capacity of the entire physical machines and the number of the virtual machines which need to be migrated for all combinations of the multiple arrangements of the virtual machines which are operating and the virtual machines which are scheduled to operate and adopts an arrangement where the number of the virtual machines which need to be migrated from the physical machines in which the virtual machines are operating to other physical machine is minimum or an arrangement in which the standard deviation of the arrangement scores is minimum to achieve the optimal arrangement of the virtual machines.

Next, a third embodiment will be described. In the above-described embodiment, it is assumed that a virtual machine which already operates for a predetermined period of time from the time when the virtual machine which is scheduled to operate starts to operate and a virtual machine which starts to operate during that time do not end, interrupt, and stop the operation. In contrast, in the third embodiment, in consideration of a case when the operating machine may end the operation during that time, the optimal arrangement of the multiple virtual machines including the virtual machine which is scheduled to operate is determined.

Therefore, the resource management server 0100 determines the arrangement of the virtual machines which are scheduled to operate by including not only the operation starting time of the virtual machine but also the operation ending time in an element to determine the optimal arrangement. The resource management program determines the arrangement of the multiple virtual machines which are scheduled to operate in the order of operation starting time. When an arrangement of some virtual machines which are scheduled to operate is determined, if there is a virtual machine which ends the operation before the operation starting time of the virtual machine which is scheduled to operate, the load is subtracted from the load of the physical machine correspondingly and an actual value of the load of the physical machine immediately before the operation starting time of the virtual machine which is scheduled to operate is calculated. The arrangement of the virtual machines to be scheduled to operate is determined based on the calculated load of each of the physical machines.

Hereinafter, the third embodiment will be described with reference to a flowchart. Also in this embodiment, as an index for optimally arranging the virtual machines in the physical machines, the virtual machines are arranged so as to equalize available capacities of multiple physical machines in the computer system. The difference of the third embodiment from the two embodiments described above is that in the processings in the third embodiment, the arrangement of the multiple virtual machines is reconfigured in consideration of the ending time of the virtual machine which is scheduled to operate.

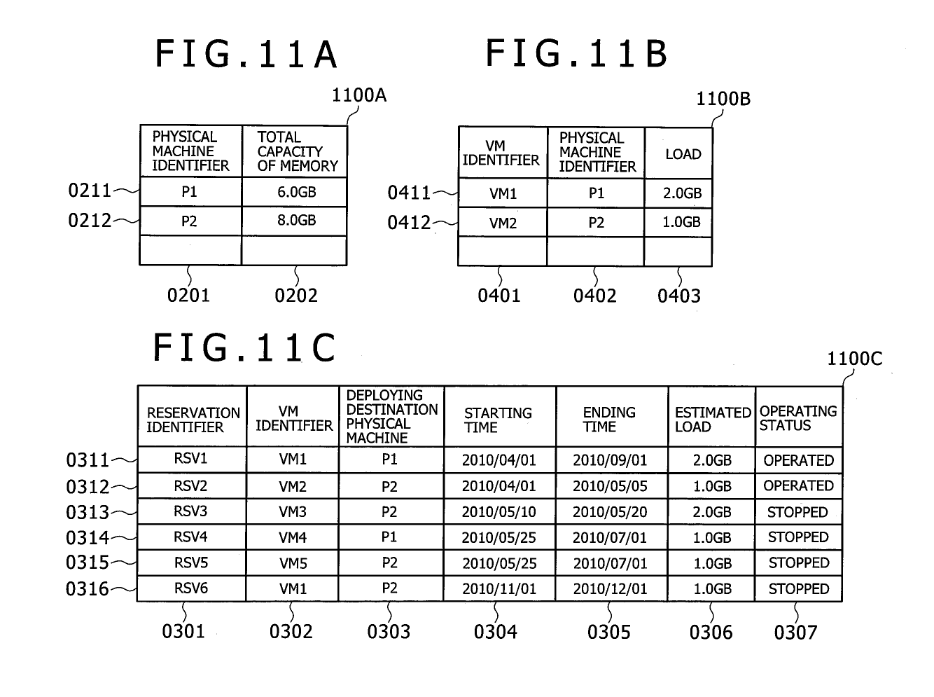

FIG. 11A illustrates a physical machine information table 1100A of this embodiment, FIG. 11B illustrates a VM information table 1100B, and FIG. 11C illustrates a reservation information table 1100C. Except the reservation information table, configuration of the other tables is the same as the above-described embodiment. The difference of the reservation information table from the reservation information tables of the above-described embodiments is that an operating status field 0307 is included.

In the operating status field 0307, an identifier indicating an operating status of the virtual machine identified in a VM identifier field 0302 of each row of the reservation information table 1100C is stored. The operating status includes two statuses, such as “operated” and “stopped”. “Operated” indicates a status that the virtual machine operates on the physical machine by the reservation. “Stopped” indicates a status that the virtual machine does not operate on the physical machine by the reservation. In a row in which the “operated” is stored in the operating status field 0307, the identifier of the virtual machine stored in the VM identifier field 0302 is necessarily present in a VM identifier field of the VM information table 1100B. For example, in the row 0311 of the reservation information table 1100C of FIG. 11, “operated” is stored in the operating status field 0307 and an identifier “VM1” is stored in the VM identifier field 0302 so that a row 0411 in which the identifier “VM1” is stored in the VM identifier field 0401 is present in the VM information table 1100B.

Further, even though the virtual machine operates, if the operation is not a scheduled operation by the reservation, “stopped” is stored in the operating status field 0307. For example, in a row 0316 of the reservation information table 1100C of FIG. 11, even though an identifier “VM1” of the virtual machine which is operating is stored in the VM identifier field 0302, the virtual machine “VM1” operates by the reservation indicated not by the row 0316, but by the row 0311 so that “stopped” is stored in the operating status field 0307 of the row 0316.

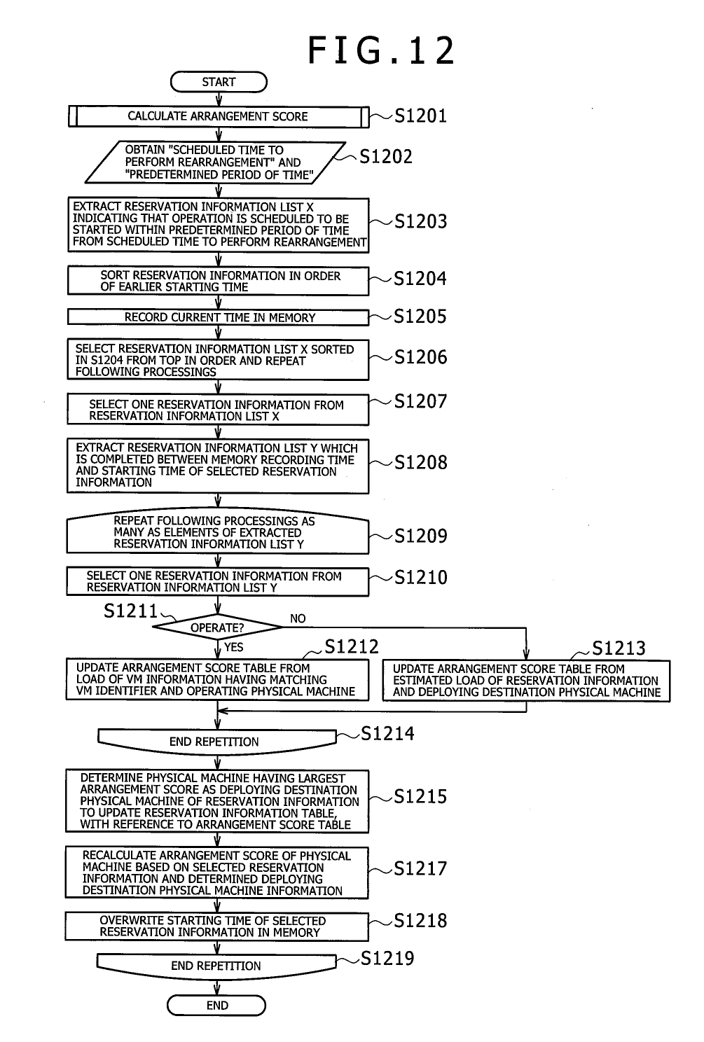

FIG. 12 is a flowchart for determining an optimal arrangement of the virtual machines which are scheduled to operate in the third embodiment. This flowchart is executed by the resource management program 0110. First, the resource management program 0110 executes step S1201 at an arbitrary time. The arbitrary time refers to, for example, a time which is set in the resource management server 0100 by a user.

Step S1201 is the same processing as the processing from steps S0501 to S0505 of the flowchart of FIG. 5. The resource management program 0110 calculates an arrangement score of each of the physical machines from a load of the virtual machine which is operating and a total memory capacity of the physical machines and records the arrangement score in the arrangement score table 0600 of FIG. 6.

Step S1202 is the same processing as step S0701 of FIG. 7. Step S1203 is the same processing as step S0702 of the flowchart of FIG. 7. In step S1204, the reservation information extracted in step S1203 is sorted in an ascending order of the starting time.

In step S1205, a current time is set as an initial value of time information to be recorded in a predetermined region of the memory 0102 of the management server (hereinafter, referred to as time information). In step S1206, the processings from step S1207 to step S1219 are repeatedly performed until all reservation information extracted in step S1203 is referred to. In step S1207, one of extracted reservation information is selected.

In step S1208, all reservation information indicating that the operation ends during the period from a time indicated by the time information to the starting time of the selected reservation information is extracted referring to the reservation information table 1100C. For example, if the time information is midnight on May 1, 2010 and the reservation information selected in step S1207 is the row 0313, the starting time field 0304 of the row 0313 is May 10, 2010 so that in step S1208, a row 0312 whose ending time field 0305 is May 5, 2010 is extracted.

In step S1209, the processings to step S1214 are repeatedly performed until all reservation information extracted in step S1208 is referred to. In step S1210, one of reservation information extracted in step S1208 is selected.

In step S1211, it is determined whether the reservation information selected in step S1210 is the reservation information of the virtual machine which is operating or the reservation information of the virtual machine which is scheduled to operate. In the case of the virtual machine which is operating, the processing of step S1212 is performed and in the case of the virtual machine which is scheduled to operate, the processing of step S1213 is performed. Specifically, if the identifier stored in the operating status field 0307 of the reservation information selected in step S1210 is “operated”, the processing of step S1212 is performed and if the identifier is “stopped”, the processing of step S1213 is performed.

In step S1212, the arrangement score table 0600 of FIG. 6 is updated based on the load of the virtual machine which is operating, identified by the VM identifier field 0302 of the reservation information selected in step S1210. Specifically, a row in which the VM identifier 0401 matches with an identifier stored in the VM identifier field 0302 of the reservation information selected in step S1210 is extracted from the VM information table 1100B. An arrangement score of the physical machine when the load of the virtual machine stored in the load field 0403 of the extracted row is subtracted from a load of the physical machine identified by an identifier stored in the physical machine identifier field 0402 of the extracted row is recalculated and then updated and registered in the arrangement score table 0600.

For example, if the arrangement score is defined as an available capacity of each of the physical machines and the reservation information selected in step S1210 is the row 0312 of the reservation information table 1100C, a virtual machine to be reserved is a virtual machine whose identifier stored in the field 0302 of the row 0312 is “VM2”, and based on the VM information table 1100B, the row whose VM identifier field 0401 is “VM2” is a row 0412.

The load field 0403 of the row 0412 of the VM information table 1100B is “1.0 GB”, the physical machine identifier 0402 is “P2” and a row where “P2” is stored in the physical machine identifier field 0601 of the arrangement score table illustrated in FIG. 6 is a row 0612, and an arrangement score field 0602 of the row 0612 is “7.0”. It shows the available memory of the physical machine P2 is 7.0 GB and if the load “1.0 GB” of the VM2 indicated by the row 0412 is subtracted from the load of the physical machine P2, an actual available memory of the physical machine P2 is 8.0 GB. Therefore, 8.0 is stored in the arrangement score field 0602 of the row 0612 of the arrangement score table 0600.

In step S1213, the arrangement score table 0600 of FIG. 6 is updated based on the load stored in the estimated load field 0306 of the reservation information selected in step S1210. Specifically, in step S1210, the arrangement score of the physical machine when the load stored in the estimated load field 0306 of the selected reservation information is subtracted from the load of the physical machine identified by the identifier stored in the deploying destination physical machine field 0303 is calculated and the arrangement score is stored in the arrangement score table 0600.

For example, if the resource management program 0110 defines the arrangement score as available memory of each of the physical machines, when the reservation information selected in step S1210 is the row 0314 of the reservation information table 1100C, the estimated load field 0306 of the row 0314 is “1.0 GB”, the deploying destination physical machine field 0402 is “P1”, a row in which “P1” is stored in the physical machine identifier field 0601 of the arrangement score table illustrated in FIG. 6 is a row 0611, and 4.0 is stored in the arrangement score field 0602 of the row 0611. Therefore, in step S1213, it shows the available memory of the physical machine P1 is 4.0 GB, and if the estimated load “1.0 GB” of the VM indicated by the row 0314 is subtracted from the load of the physical machine P1, the available memory of the physical machine P2 is 5.0 GB so that 5.0 is stored in the arrangement score field 0602 of the row 0611 of the arrangement score table 0600.

Step S1214 is a termination step corresponding to step S1209 which is a beginning step of repetitive steps. The above-described steps are repeatedly performed until all reservation information extracted in step S1208 is referred to.

The processings of steps S1215 and S1217 are the same as the processings of steps S0705 and 0706 illustrated in FIG. 7. In step S1218, the time which is stored in the starting time field 0304 of the reservation information selected in step S1207 is overwritten in the memory which is initialized in step S1205 to be recorded. Step S1219 is a termination step corresponding to step S1206 which is a beginning step of return steps and the above-described steps are repeatedly performed until all reservation information extracted in step S1203 is referred to.

In this embodiment, if the arrangement score of each of the physical machines is calculated when the load of each of the physical machines from the starting time to the ending time of the selected reservation information is calculated from the estimated load, the starting time, and the ending time of the virtual machine which is operating and the virtual machine which is scheduled to operate, whose arrangement is already determined, it does not need to determine the arrangement of the virtual machines which are scheduled to operate from the earlier starting time.

When the resource management program selects a virtual machine which is scheduled to operate to determine the arrangement thereof, the load of each of the physical machines during the operating period of the selected virtual machine is calculated from the load of the virtual machines which concurrently operate during the operating period of the selected virtual machine and the arrangement of the selected virtual machine which is scheduled to operate is determined based on the calculated load of each of the physical machines so that even when the virtual machine which is operating or the virtual machine which is scheduled to operate end the operation within a predetermined period of time from the rearrangement performing time, it is possible to determine the optimal arrangement of the virtual machines which are scheduled to operate.

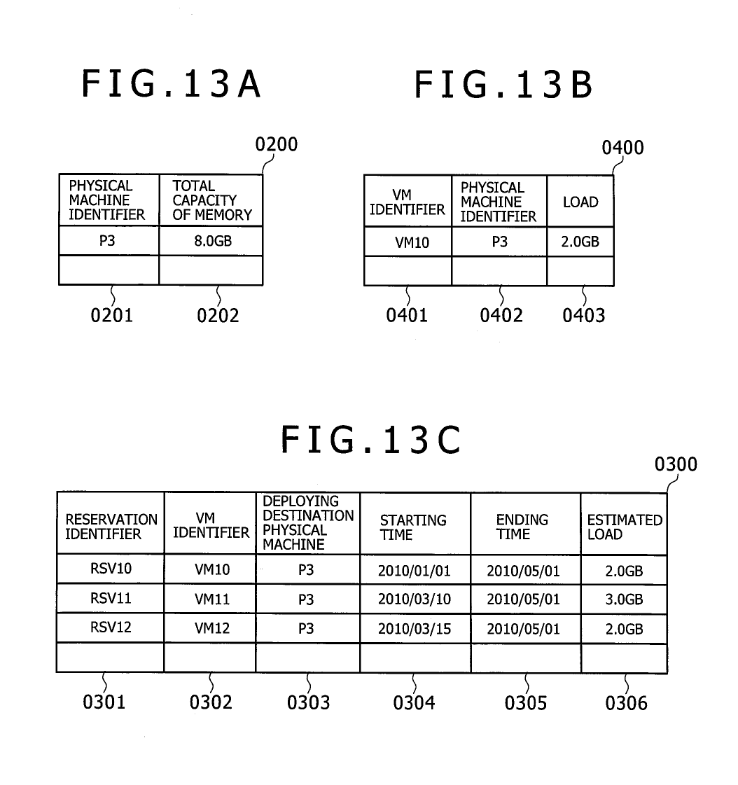

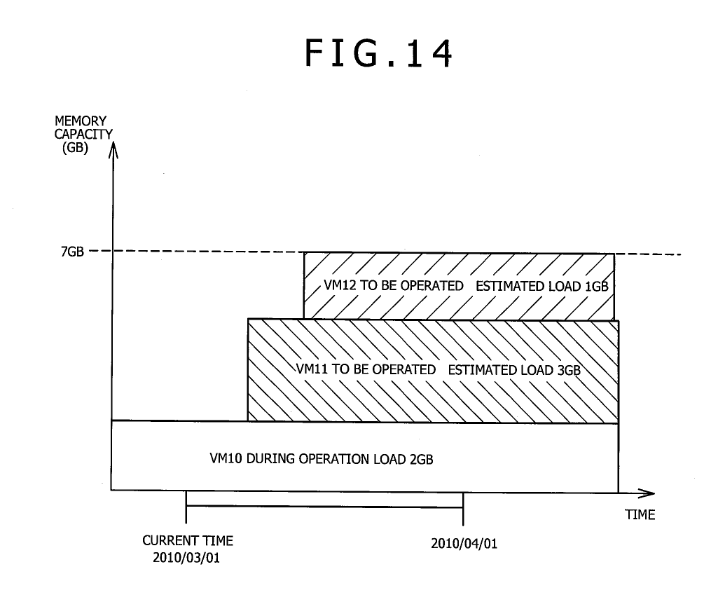

FIGS. 13A to 13C are management tables regarding a status where the ending time of the virtual machine which is operating does not needs to be considered when the resource management program 0110 determines the arrangement of the virtual machines which are scheduled to operate, specifically, FIG. 13A illustrates a physical machine information table 0800A, FIG. 13B illustrates a VM information table, and FIG. 13C illustrates a reservation information table 0800C. In FIG. 14, a displacement of a load of the virtual machine with respect to a total memory capacity of a physical machine P3 is illustrated in a graph. Referring to FIG. 13C, a virtual machine VM10 which is scheduled to operate already operates in a physical machine P3 at a current time (Mar. 1, 2010) and a virtual machine VM11 and a virtual machine VM12 continuously operate in the physical machine P3 to one month (to Apr. 1, 2010) from the current time again and the three virtual machines VM10, VM11, VM12 do not stop the operations during the period. Therefore, the resource management program 0110 determines to arrange the virtual machines VM11 and VM12 which are scheduled to operate in the physical machine P3 at the current time and when the virtual machines operate, it does not need to subtract the load of the virtual machine which is completely arranged in the physical machine P3 from the total memory capacity of the physical machine P3.

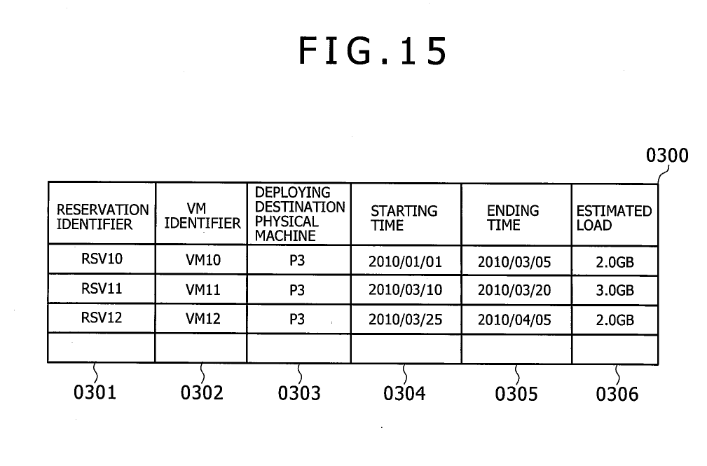

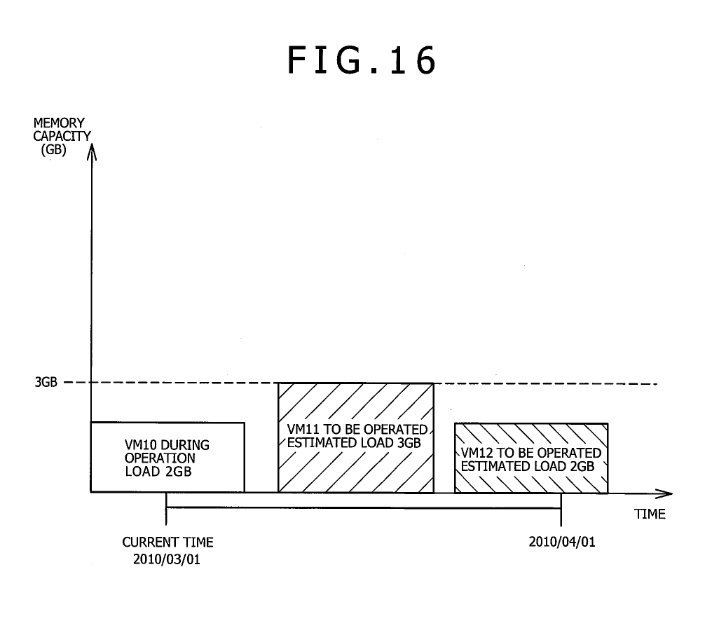

In contrast, a case where the load needs to be subtracted from the total memory capacity will be described below. FIG. 15 is a modification of the reservation information table of FIG. 13C. According to the reservation information table of FIG. 15, the virtual machine VM10 and the virtual machine VM11 are temporarily arranged and operate in the physical machine P3 within one month from the current time (Mar. 1, 2010), but the operation ends by Apr. 1, 2010. Therefore, an actual estimated load of the virtual machine arranged in the physical machine P3 during the period becomes the value of the estimated load of the virtual machine VM11 (FIG. 16). Therefore, the resource management program 0110 calculates the above described arrangement score of the physical machine P3 necessarily based on a value of the estimated load of the physical machine P3.

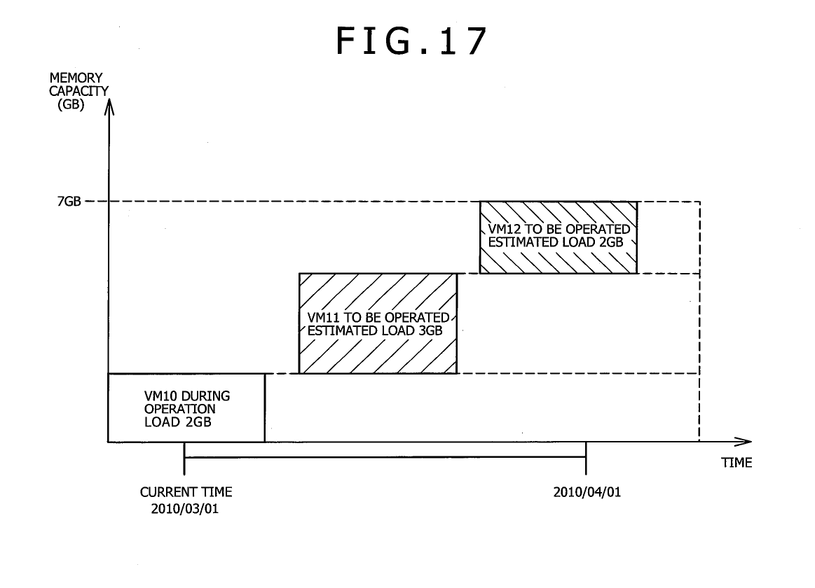

In the meantime, if the end of the operation of the virtual machine VM10 and the virtual machine VM11 is not considered, even though the load of the virtual machines is not present in the physical machine P3, as illustrated in FIG. 17, the loads are accumulated in the load of the virtual machine VM12 and the arrangement score is based on the accumulation. Therefore, even when the capacity of the physical machine P3 has an available capacity of the physical machine P3, the management program determines that the physical machine P3 does not have an available capacity and determines other physical machine as the arrangement destination of the virtual machine VM11 and/or the virtual machine VM12 so that the object of the optimal arrangement of the virtual machine which is scheduled to operate may not be achieved.

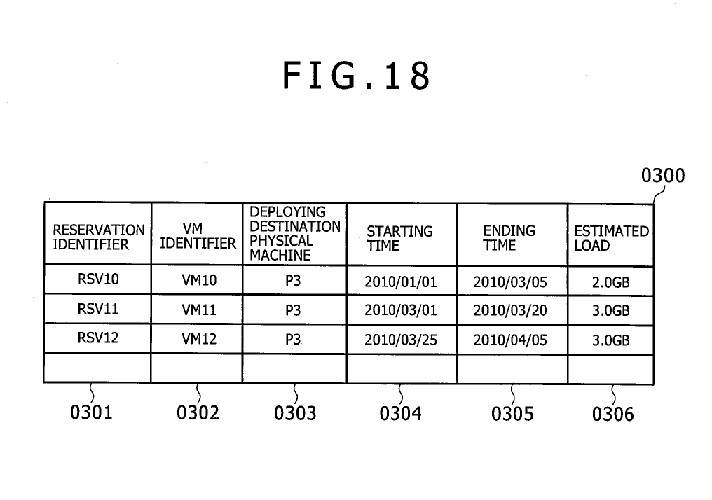

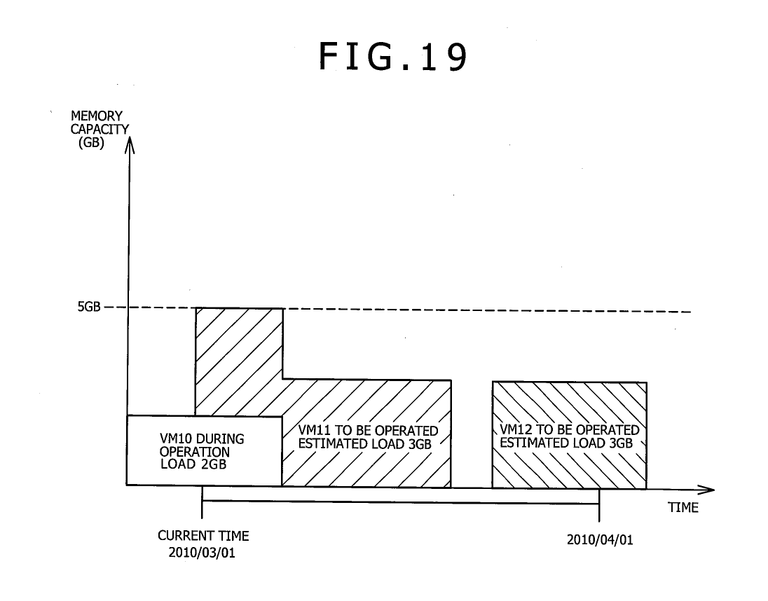

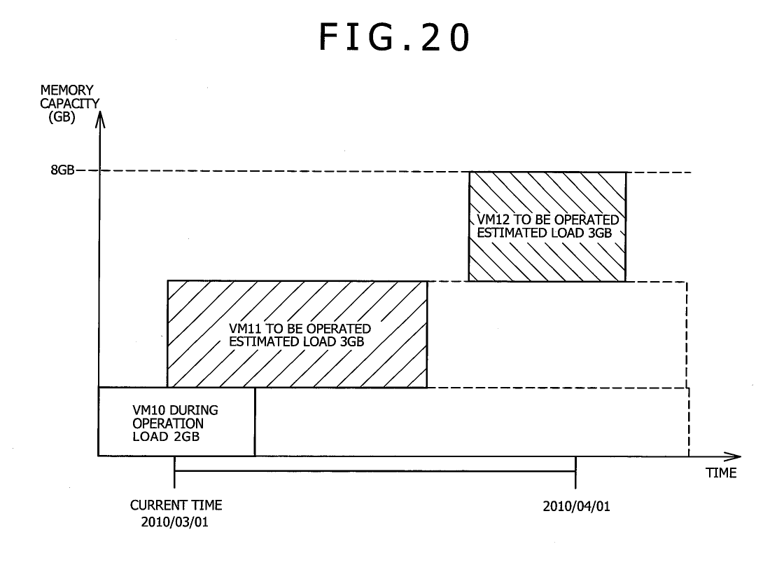

FIGS. 18 to 20 are other examples of FIGS. 15 to 17. FIG. 18 illustrates a reservation information table, FIG. 19 illustrates a displacement of the load of the virtual machine in the physical machine P3 when the end of the operation of the virtual machine is considered, and FIG. 20 illustrates a displacement of the load of the virtual machine in the physical machine P3 when the end of the operation of the virtual machine is not considered. The difference of this embodiment from the above embodiments is that in FIG. 19, a maximum value of the estimated load for a predetermined period (one month) from the current time (Mar. 1, 2010) may be a value obtained by adding both values of the virtual machine VM10 and the virtual machine VM11 because the operating periods of the virtual machine VM10 and the virtual machine VM11 partially overlap.

In the above described reservation information table (FIG. 4), the managing user may designate a physical machine in which a virtual machine which is scheduled to operate is arranged. For example, a virtual machine is arranged in a specific physical machine. If the virtual machine necessarily operates on the physical machine, the managing user designates the arrangement destination physical machine of the virtual machine and if the virtual machine is out of the rearrangement target, or if a virtual machine is restricted so as to move between multiple specific physical machines, the managing user designates the range of the arrangement destination physical machine of the virtual machine. If the virtual machine is optimally arranged, the arrangement of the virtual machine is determined within the range of the physical machine designated when the arrangement destination is determined.

In addition to designation of the arrangement destination physical machine of the virtual machines, the managing user may put a restriction on the arrangement of the virtual machines. For example, multiple designated virtual machines operate in the same physical machine, or multiple designated virtual machines operate in different physical machines, or multiple designated virtual machines is arranged in a physical machine having a short network distance if possible.

What is claimed is:

1. A computer system, comprising:
a plurality of physical machines; and
a management computer which is connected to the plurality of physical machines through a network to manage an arrangement of a plurality of virtual machines in the plurality of physical machines,
wherein the management computer determines the virtual machine which is scheduled to operate from schedule information which operates the virtual machines, and
based on a load regarding a virtual machine which is operating and which is already arranged in one or the plurality of physical machines to operate,
determines a physical machine in which the virtual machine which is scheduled to operate is arranged from the plurality of physical machines before operating the virtual machine.

2. A computer system according to claim 1, wherein the management computer calculates a load regarding the virtual machine which is operating from a value obtained by subtracting a resource amount allocated into the virtual machine which is operating from a total allocatable resource amount from each of the plurality of physical machines to the virtual machine.

3. A computer system according to claim 1, wherein the management computer includes a management table in which the virtual machine which is scheduled to operate is registered,
the management table includes information of a time when the virtual machine starts the operation and information of a time when the virtual machine ends the operation, and
the management computer extracts a virtual machine which is scheduled to operate whose starting time is present within a predetermined period of time from a scheduled time from the management table and determines the physical machine in which the extracted virtual machine is arranged.

4. A computer system according to claim 1, wherein the management computer determines the virtual machines which are scheduled to operate from the plurality of physical machines without migrating the virtual machine which is operating in any one of the plurality of physical machines to other physical machine.

5. A computer system according to claim 1, wherein the management table includes information of an arrangement destination physical machine of the virtual machine which is scheduled to operate, and
if the physical machine which is determined to arrange the virtual machine which is scheduled to operate therein is different from the arrangement destination physical machine included in the management table, the management computer updates and registers information of the determined physical machine in the management table.

6. A computer system according to claim 1, wherein the management computer determines the virtual machines which are scheduled to operate from the plurality of physical machines while migrating the virtual machine which is operating in any one of the plurality of physical machines to other physical machine.

7. A computer system according to claim 6, wherein the management computer, after determining a physical machine in which the virtual machine which is scheduled to operate is arranged, determines whether the load regarding the virtual machine which is scheduled to operate and a load regarding other virtual machine which is operating at least one of the plurality of physical machines accomplish a target value,
if the determination is denied, migrates at least one of the plurality of virtual machines which is operating in at least one of the plurality of physical machines to other physical machine, and if the determination is affirmed, determines the arrangement of the plurality of virtual machines in the plurality of physical machines without performing the migration.

8. A computer system according to claim 7, wherein the management computer selects, as the previously mentioned other physical machine, a physical machine having the largest resource amount which is allocated to at least one of the virtual machines from the plurality of physical machines.

9. A computer system according to claim 1, wherein when a target physical machine in which the virtual machine which is scheduled to operate is arranged is determined, if a virtual machine which operates before starting the operation of the virtual machine and ends the operation is arranged in the target physical machine, the management computer determines the target physical machine from the plurality of physical machines without subtracting the load regarding the virtual machine from the resource amount of the target physical machine.

10. A computer system according to claim 1, wherein the management computer calculates a load regarding the virtual machine which is operating from a value obtained by subtracting a resource amount allocated into the virtual machine which is operating from a total resource amount which is allocated from each of the plurality of physical machines to the virtual machine, and includes a management table in which the virtual machine which is scheduled to operate is registered,
the management table includes information of a time when the virtual machine starts the operation and information of a time when the virtual machine ends the operation,
the management computer extracts a virtual machine which is scheduled to operate whose starting time is present within a predetermined period of time from a scheduled time from the management table and determines the physical machine in which the extracted virtual machine is arranged,
the management table includes information of an arrangement destination physical machine of the virtual machine which is scheduled to operate, and
the management computer, if the physical machine which is determined to arrange the virtual machine which is scheduled to operate therein is different from the arrangement destination physical machine included in the management table, further updates and registers information of the determined physical machine in the management table,
determines the virtual machines which are scheduled to operate from the plurality of physical machines while migrating the virtual machine which is operating in any one of the plurality of physical machines to other physical machine,
after determining a physical machine in which the virtual machine which is scheduled to operate is arranged, determines whether the load regarding the virtual machine which is scheduled to operate and a load regarding other virtual machine which is operating at least one of the plurality of physical machines accomplish a target value,
if the determination is denied, migrates at least one of the plurality of virtual machines which is operating in at least one of the plurality of physical machines to other physical machine, and if the determination is affirmed, determines the arrangement of the plurality of virtual machines in the plurality of physical machines without performing the migration,
determines, as the previously mentioned other physical machine, a physical machine having the largest resource amount which is allocated to at least one of the virtual machines from the plurality of physical machines, and
when a target physical machine in which the virtual machine which is scheduled to operate is arranged is determined, if a virtual machine which operates before starting the operation of the virtual machine and ends the operation is arranged in the target physical machine, determines the target physical machine from the plurality of physical machines without subtracting the load regarding the virtual machine from the resource amount of the target physical machine.

11. An optimal arrangement method of virtual machines in a computer system, comprising:
a plurality of physical machines; and
a management computer which is connected to the plurality of physical machines through a network to manage an arrangement of a plurality of virtual machines in the plurality of physical machines,
wherein the management computer determines the virtual machine which is scheduled to operate from schedule information which operates the virtual machines, and
based on a load regarding a virtual machine which is operating and which is already arranged in one or the plurality of physical machines to operate,
determines a physical machine in which the virtual machine which is scheduled to operate is arranged from the plurality of physical machine before operating the virtual machine.
